(19) United States
(12) Patent Application Publication
(10) Pub. No.: US 2026/0099751 A1
(43) Pub. Date: Apr. 9, 2026

(54) METHODS AND ARRANGEMENTS FOR COUPLING A QUANTUM MECHANICAL SYSTEM TO A QUANTUM MECHANICAL ENVIRONMENT

(71) Applicant: IQM FINLAND OY, Espoo (FI)

(72) Inventors: Akseli MÄKINEN, Espoo (FI); Mikko MÖTTÖNET, Espoo (FI)

(21) Appl. No.: 19/115,070

(22) PCT Filed: Aug. 31, 2023
(86) PCT No.: PCT/FI2023/050497

§ 371 Date: Mar. 25, 2025

(30) Foreign Application Priority Data
Sep. 30, 2022 (WO) PCT/F12022/050655

(51) Int. Cl. G06N 10/40

(52) U.S. Cl. CPC G06N 10/40

(57) ABSTRACT

A quantum information processing system may comprise a quantum mechanical system capable of exhibiting transitions between a plurality of eigenstates; and a quantum control environment, wherein the quantum control environment eigenstates is capable of exhibiting modes from a continuous spectrum and is coupled to the quantum mechanical system at at least one coupling location, wherein said coupling is characterized with a set of parameters of the quantum mechanical system, and wherein a selected combination of the at least one coupling location and the set of parameters intentionally causes to suppress at least one of said transitions when intentionally changing a state of the quantum mechanical system by the quantum control environment.

### TECHNICAL FIELD

Example embodiments of the present disclosure are generally related to quantum information processing. In particular, some example embodiments are directed to hardware and methods for delivering information between the quantum mechanical system and the quantum mechanical environment such that transitions between certain quantum states of the quantum mechanical system are intentionally suppressed.

### BACKGROUND

Quantum information processing systems may perform calculations using qubits, which may be provided on quantum mechanical systems capable of exhibiting transitions between their states. A qubit circuit may be driven by injecting a driving (or excitation) signal through a driving port. The state acquired by the qubit circuit (qubit) may be read through a readout port. An optional bias signal, coupled to the qubit circuit through an optional bias port, may be used to affect the operating characteristics of the qubit circuit, for example to change its resonance frequency or otherwise affect the way in which the qubit responds to drive and readout operations.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable filtering the noise spectrum when delivering information between a quantum mechanical system and its environment.

These and further benefits may be achieved by the features of the independent claims. Further example embodiments are provided in the claims, description, and/or drawings.

According to a first aspect, there is provided a quantum information processing system. The quantum information processing system may comprise a quantum mechanical system capable of exhibiting transitions between a plurality of eigenstates; and a quantum mechanical environment, wherein the quantum mechanical environment is capable of exhibiting modes from a continuous spectrum and is coupled to the quantum mechanical system at at least one coupling location, wherein said coupling is characterized with a set of parameters of the quantum mechanical system, and wherein a selected combination of the at least one coupling location and the set of parameters intentionally causes to suppress at least one of said transitions when intentionally changing a state of the quantum mechanical system by the quantum mechanical environment. This yields at least the advantage that some undesired effects, such as decoherence, of the intentionally changing the state of the quantum mechanical system are suppressed.

According to a second aspect, a method for coupling a quantum mechanical system to a quantum mechanical environment is disclosed, wherein the quantum mechanical system is capable of exhibiting transitions between a plurality of eigenstates. The method may comprise: providing at least one coupling location for coupling the quantum mechanical system to the quantum mechanical environment, wherein the quantum mechanical environment is capable of exhibiting modes from a continuous spectrum, and wherein said coupling is characterized with a set of parameters of the quantum mechanical system; and coupling the quantum mechanical system to the quantum mechanical environment through the at least one coupling location, wherein a selected combination of the at least one coupling location and the set of parameters intentionally causes to suppress at least one of said transitions when intentionally changing a state of the quantum mechanical system by the quantum mechanical environment This yields at least the advantage that some undesired effects, such as decoherence, of the intentionally changing the state of the quantum mechanical system are suppressed.

According to an example embodiment of the first or second aspect, said intentionally changing the state of the quantum mechanical system by the quantum mechanical environment comprises delivering information between the quantum mechanical system and the quantum mechanical environment or controlling the quantum mechanical system by the quantum mechanical environment. This yields at least the advantage that decoherence during the delivery of information to/from the quantum mechanical system or controlling the state of the quantum mechanical system is suppressed.

According to an example embodiment of the first or second aspect, the set of parameters characterizing the coupling comprises at least one parameter of the quantum mechanical environment. This yields at least the advantage that characteristics of the environment are taken into account, resulting in more accurate suppression of decoherence caused by the intentional state change.

According to an example embodiment of the first or second aspect, the selected combination of the at least one coupling location and the set of parameters is configured to reduce or minimize an absolute value of at least one transition matrix element Mₖₗ of a transition matrix between eigenstates of the quantum mechanical system, wherein k and l are indices of two of said eigenstates. This yields at least the advantage that such reduction or minimization reduces or minimizes the probability of the corresponding transition of the state of the quantum mechanical system.

According to an example embodiment of the first or second aspect, said intentionally changing the state of the quantum mechanical system comprises driving a quantum mechanical state of the quantum mechanical system with at least one driving signal, resetting or cooling the quantum mechanical system, or reading out the quantum mechanical state of the quantum mechanical system. This yields at least the advantage that the fidelity of the corresponding qubit operation is increased.

According to an example embodiment of the first or second aspect, the quantum mechanical environment comprises a dissipative element.

According to an example embodiment of the first or second aspect, the quantum mechanical system comprises a unimon qubit circuit comprising a coplanar waveguide, wherein the coplanar waveguide is intercepted by at least one Josephson junction and has a length between its two ends, wherein the unimon qubit circuit is configured with a plurality of modes.

According to an example embodiment of the first or second aspect, the at least one coupling location comprises a single coupling location along the length of the coplanar waveguide. This involves at least the advantage that the number of coupling locations, and components associated therewith, may be reduced while enabling the state transition(s) to be suppressed.

According to an example embodiment of the first or second aspect, the at least one coupling location comprises a plurality of coupling locations, and wherein said intentionally changing the state of the quantum mechanical system comprises driving the state of the quantum mechanical system to a second or third excited state through the at least one coupling location and reading out the state of the quantum mechanical system based on photons absorbed to the quantum mechanical environment through the at least one coupling location as a consequence of a transition from the second or third excited state to a lower excited state.

According to an example embodiment of the first or second aspect, the unimon qubit circuit comprises a multiunimon qubit circuit configured with a plurality of modes acting as qubits, and wherein coupling of the plurality of modes is configured to cause coupling between the qubits.

According to an example embodiment of the first or second aspect, the quantum mechanical system comprises a plurality of the unimon qubit circuits coupled to each other and configured to operate as a multi-qubit quantum processor enabling entanglement between qubits.

According to an example embodiment of the first or second aspect, the quantum mechanical environment comprises a quantum circuit refrigerator comprising at least one normal-metal-insulator-superconductor (NIS) tunnel junction electrically connected to the quantum mechanical system, and at least one superconductive lead electrically connected to the at least one normal-metal-insulator-superconductor (NIS) tunnel junction for supplying a drive voltage for said at least one normal-metal-insulator-superconductor (NIS) tunnel junction.

According to an example embodiment of the first or second aspect, the quantum mechanical environment comprises an Ohmic resistor or a transmission line.

According to an example embodiment of the first or second aspect, the unimon qubit circuit is configured with substantially two modes, and the single coupling location is based on a ratio of envelope functions of the two modes at the single coupling location.

According to an example embodiment of the first or second aspect, the quantum mechanical system comprises a plurality of transmon qubit circuits, and the at least one coupling location comprises a plurality of coupling locations configured to couple the plurality of transmon qubit circuits to the quantum mechanical environment through a sum of charge or a difference of charge of the plurality of transmon qubit circuits.

According to an example embodiment of the first or second aspect, the quantum mechanical environment comprises a quantum circuit refrigerator comprising at least one normal-metal-insulator-superconductor (NIS) tunnel junction electrically connected to the quantum mechanical system, and at least one superconductive lead electrically connected to the at least one normal-metal-insulator-superconductor (NIS) tunnel junction for supplying a drive voltage for said at least one normal-metal-insulator-superconductor (NIS) tunnel junction, or wherein the quantum mechanical environment comprises an Ohmic resistor.

According to an example embodiment of the first or second aspect, the quantum mechanical system comprises a plurality of resonator circuits, and the at least one coupling location comprises a plurality of coupling locations configured to couple the plurality of resonator circuits to the quantum mechanical environment through a sum of charge or a difference of charge of the plurality of resonator circuits.

According to an example embodiment of the first or second aspect, the plurality of resonator circuits have substantially same resonance frequency.

According to an example embodiment of the first or second aspect, at least one of the plurality of resonator circuits is tunable to the substantially same resonance frequency. This yields at least the advantage that accuracy of suppressing the state transition(s) may be improved after manufacturing.

According to an example embodiment of the first or second aspect, the quantum mechanical environment comprises a quantum circuit refrigerator comprising at least one normal-metal-insulator-superconductor (NIS) tunnel junction electrically connected to the quantum mechanical system, and at least one superconductive lead electrically connected to the at least one normal-metal-insulator-superconductor (NIS) tunnel junction for supplying a drive voltage for said at least one normal-metal-insulator-superconductor (NIS) tunnel junction.

According to an example embodiment of the first or second aspect, the quantum mechanical system comprises a unimon qubit circuit comprising a coplanar waveguide, the coplanar waveguide is intercepted by at least one Josephson junction and has a length between its two ends, and the unimon qubit circuit is configured with a plurality of modes.

According to an example embodiment of the first or second aspect, the at least one coupling location comprises a single coupling location along the length of the coplanar waveguide. This yields at least the advantage that the number of coupling locations, and components associated therewith, may be reduced while enabling the state transition(s) to be suppressed.

According to an example embodiment of the first or second aspect, a first mode of the unimon qubit circuit is configured for use as a qubit mode, a second mode of the unimon qubit circuit is configured for use as a qubit read-out mode, and the at least one coupling location comprises two coupling locations along the length of the coplanar waveguide.

According to an example embodiment of the first or second aspect, the two coupling locations are based on a ratio of envelope functions of the qubit mode at the two coupling locations and frequencies of the two modes.

According to an example embodiment of the first or second aspect, the ratio of envelope functions of the qubit modes at the two coupling locations is configured to satisfy a condition, where the condition is dependent on the frequencies of the two modes.

According to an example embodiment of the first or second aspect, the quantum control environment comprises a transmission line.

According to an example embodiment of the first or second aspect, the quantum mechanical system comprises a transmission line, the quantum mechanical environment comprises a quantum circuit refrigerator comprising at least one normal-metal-insulator-superconductor (NIS) tunnel junction electrically connected to the quantum mechanical system, and at least one superconductive lead electrically connected to the at least one normal-metal-insulator-superconductor (NIS) tunnel junction for supplying a drive voltage for said at least one normal-metal-insulator-superconductor (NIS) tunnel junction, the at least one coupling location comprises two coupling locations, and a distance between the two coupling locations is an odd multiple of a half-wavelength of a mode of the transmission line that is configured to be intentionally not filtered.

Example embodiments of the above aspects are described in the claims, the description, and/or the drawings. According to some aspects, there is provided the subject matter of the independent claims. Some further aspects are defined in the dependent claims. Many of the attendant features will be more readily appreciated as they become better understood by reference to the following description considered in connection with the accompanying drawings.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates some concepts related to quantum information processing,

FIG. 2 illustrates an example of coupling between a quantum mechanical system and a quantum mechanical environment,

FIG. 3 illustrates an example of a quantum circuit refrigerator,

FIG. 4 illustrates a unimon with capacitive couplings and an inductive element,

FIG. 5 illustrates an example of a single coupling location and a set of parameters for suppressing a state transition in case of a two-mode unimon,

FIG. 6 illustrates an example of transition matrix elements as functions of scaled QCR (quantum circuit refrigerator) coupling location in case of a two-mode unimon,

FIG. 7 illustrates examples of two transmon qubits coupled to a QCR through (a) sum or (b) difference of their charge operators,

FIG. 8 illustrates examples of two resonators coupled to a QCR through (a) sum or (b) difference of their charge operators,

FIG. 9 illustrates an example of two transmon qubits coupled to an Ohmic resistor through (a) sum or (b) difference of their charge operators,

FIG. 10 illustrates an example of a quantum mechanical system, in this example a QCR, coupled to a transmission line, and

FIG. 11 illustrates an example of a method for coupling a quantum mechanical system to a quantum mechanical environment.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense.

For instance, it is understood that a disclosure in connection with a described method may also hold true for a corresponding device or system configured to perform the method and vice versa. For example, if a specific method step is described, a corresponding device may include a unit (e.g., circuitry) configured to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

Example embodiments of the present disclosure provide coupling schemes of environments for electric devices, e.g., quantum mechanical systems, where the coupling to the environment takes place at multiple coupling locations. The coupling locations may be far away from each other in terms of electrical length, thus giving rise to beneficial properties such as filtering of the noise spectrum. In addition, the example embodiments provide coupling schemes of environments for electric devices where the coupling takes place at a single location but couples to a multimode device in a way that enables filtering of the noise spectrum.

Quantum information processing systems may be configured to be operated at a cryogenic environment (e.g., a cryostat) at an extremely low temperature. The cryogenic environment may be configured to be generated for example by a dilution refrigerator, where different isotopes of Helium (³He/⁴He) are provided a mixing chamber of the dilution refrigerator to cryogenically cool the environment of the mixing chamber to cryogenic temperatures, for example in the order of a few millikelvins (mK). Example embodiments of the present disclosure may be applied in cryogenic environments. For example both the quantum mechanical system and its immediate quantum mechanical environment (e.g., an electric circuit configured to control the system or operate as band pass filter for the system) may be located at the cryogenic environment.

A quantum mechanical system may be coupled to its environment, for example in order to read out or reset the state of the quantum mechanical system. The coupling may however lead to increased decay rate and decoherence of the quantum mechanical system. It may be possible to suppress decoherence by decreasing the strength of the coupling, but this may increase the required read-out time. Hence, there is generally a trade-off between read-out time and decoherence. It may be however desired to design the coupling such that decoherence can be suppressed without excessively increasing the read-out time.

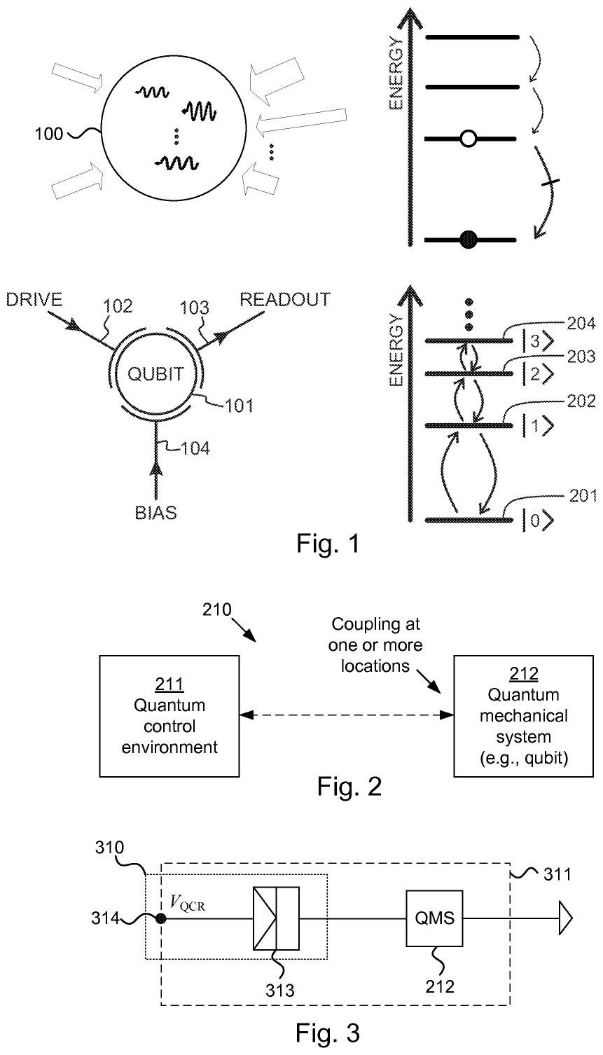

FIG. 1 illustrates schematically a quantum mechanical system 100 coupled to its environment at multiple spatial locations. An energy diagram of quantum mechanical system is illustrated on the right. The system may comprise a dissipative quantum system, such as for example a multimode bosonic quantum system. Quantum mechanical system 100 may be capable of exhibiting transitions between its eigenstates. Furthermore, quantum mechanical system 100 may be capable of exhibiting a continuous spectrum of modes. Term ‘mode’ may refer to a frequency mode, such as for example a normal mode. Certain quantum mechanical systems, such as a QCR and transmission line, may exhibit a continuous spectrum of modes. This is due to lack of boundary conditions that would restrict the possible frequencies of the modes to discrete values. For example, if a superconducting transmission line is interrupted at two points, e.g., by capacitors, such a boundary condition is imposed, and consequently, the transmission line forms a superconducting waveguide resonator capable of exhibiting only modes with a discrete spectrum.

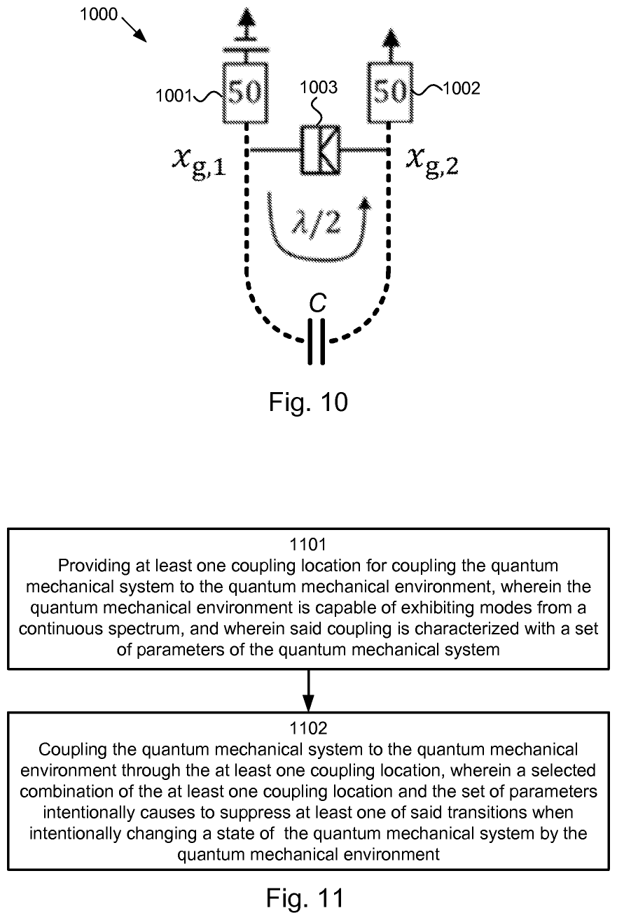

In example embodiments of the present disclosure, the quantum mechanical environment is capable of exhibiting a continuous spectrum of modes. The quantum mechanical environment may therefore comprise a continuous-mode quantum mechanical environment. The quantum mechanical system may be capable of exhibiting a continuous a discrete or spectrum of modes. For example, in the example embodiment comprising a transmission line and a QCR (see FIG. 10), the system exhibits a continuous spectrum of modes. The benefit of this embodiment is to utilize the QCR as a band-pass filter (to absorb energy). In other example embodiments the spectrum of modes of the quantum mechanical system may be discrete. The quantum mechanical environment may comprise a quantum control environment, which may be configured to enable coherent controlling of qubits (e.g., qubit driving). However, interaction between the quantum mechanical environment and the quantum mechanical system may be also non-coherent or not configured for controlling the system, for example when the quantum mechanical environment is used as a band stop filter. The quantum mechanical environment may comprise an engineered quantum environment, which may refer to a quantum mechanical environment designed to intentionally cause certain effect(s) on a given quantum system, for example quantum mechanical system 100.

According to example embodiments of the present disclosure, coupling locations and other parameters of the quantum information processing system may be selected such that some state transition(s) of the system are suppressed or cancelled, as illustrated on the schematic energy diagram on the right. For example, it may be desired to avoid dissipation caused by a transition from an excited state (white dot) to a ground state (black dot).

FIG. 1 also illustrates a qubit 101 as an example of a quantum mechanical system and an energy diagram of qubit 101. Qubit 101 may be driven by injecting a driving (or excitation) signal through a driving port 102. The state of a qubit may be defined by the state of an underlying physical qubit circuit. In this disclosure, terms qubit and qubit circuit may be used interchangeably. In particular, where the term qubit circuit is used, its function in the description is not to be taken in a limiting sense, such that the underlying system would necessarily need to have the physical appearance of a circuit. The state acquired by qubit 101 can be read through a readout port 103. An optional bias signal, coupled to the qubit 101 through an optional bias port 104, can be used to affect the operating characteristics of qubit 101, for example to change its resonance frequency or otherwise affect the way in which qubit 101 responds to drive and/or readout operations.

While it is possible to describe quantum information processing using the two lowest energy states or basis states |0> and |1> of qubits, there may be a large or an infinite number of higher-energy states (excited states) also. The basis states 201 (|0>) and 202 (|1>), as well as two higher-energy states 203 (|2>) and 204 (|3>) of qubit 101 are illustrated on the right. Driving a qubit with the intention of causing controlled transitions between the two basis states 201 and 202 tends to cause also transitions to, from, and between the higher-energy states 203 and 204. The occurrence of such transitions may be referred to as leakage out of the computational space or leakage error. It is possible to utilise at least some of the higher-energy states for certain aspects of advanced quantum information processing, but in some quantum information processing systems these transitions may decrease the accuracy of the target operation, referred to as the gate fidelity. Consequently, it may be desired to suppress unintended higher-level transitions to the extent possible. In some applications, it may be also desired to suppress incoherent transitions to the ground states. Note that example embodiments of the present disclosure provide means to suppress transitions caused by operations other than the driving. A benefit of some example embodiments of this disclosure is the suppression of the relaxation of the state of the quantum mechanical system under consideration to lower-energy states, which is caused by the coupling of the quantum mechanical system to the quantum mechanical environment.

Example embodiments of the present disclosure may be applied to bosonic quantum mechanical systems or fermionic quantum mechanical systems, or to quantum mechanical systems comprising both bosons and fermions. A bosonic quantum mechanical system is one which exclusively comprises modes, the annihilation and creation operators of which obey the bosonic commutation relations. Alternatively, one may define a bosonic quantum mechanical system as one, the composite eigenstate of the position operator of which is symmetric under operation by an exchange operator. A bosonic quantum mechanical system meant here may be capable of exhibiting transitions between at least two eigenstates, which may be called energy states and ordered according to increasing energy. Practical bosonic quantum mechanical systems may have infinitely many of such eigenstates, for which reason the expression plurality of eigenstates may be used. If the bosonic quantum mechanical system is a part of a quantum information processing system, two of said plurality of eigenstates may be considered as basis states of a computational basis of said quantum information processing system. However, to preserve generality, there is no need to make any assumptions about basis states at first in the following discussion.

Unimon is used as an example of a bosonic quantum mechanical system of the kind described above. A unimon is a bosonic quantum mechanical system that utilizes the cancellation of inductive and Josephson energies to enhance anharmonicity. This property may be useful, if the unimon is used for example as a qubit or qudit (quantum dit), in order to enable fast and high-fidelity single-qubit gates. A unimon qubit circuit may be for example based on a grounded coplanar waveguide resonator with a single-embedded Josephson junction. Unimon has some interesting properties including a relatively high anharmonicity, protection against low-frequency charge noise and partial protection against magnetic flux noise. Experiments with such unimons agree well with the theoretical model and have allowed to reach single-qubit gate fidelities of 99.9%.

A transmon (transmission line shunted plasma oscillation qubit) is a type of superconducting qubit that may comprise a Cooper-pair box (CPB) shunted by a capacitor that has large enough capacitance compared to stray capacitance of the Josephson junction of the CPB. This decreases the sensitivity of the transmon qubit to charge noise. In a circuit diagram, a transmon qubit may be presented as a superconductive resonator circuit comprising for example a capacitor connected in parallel with a Josephson junction.

A Fermionic quantum mechanical system is one which exclusively comprises modes, the annihilation and which obey the fermionic creation operators of commutation relations. Alternatively, one may define a fermionic quantum mechanical system as one, the composite eigenstate of the position operator of which is antisymmetric under operation by an exchange operator. An example of fermionic quantum mechanical system is the normal metal island of a quantum circuit refrigerator (QCR). QCR may be coupled to a transmission line causing it to operate as the quantum mechanical environment.

Coupling of a quantum mechanical system to its environment may be therefore implemented with various realizations of the quantum mechanical system itself, as well as its environment. Example embodiments of the present disclosure provide criteria for selecting suitable coupling locations, considering other parameters of the system, to cause intentional suppression of some state transition(s) of the quantum mechanical system.

FIG. 2 illustrates an example of a quantum information processing system 210 comprising coupling between quantum mechanical system 212 and quantum mechanical environment 211. Quantum mechanical system 212 may comprise superconductive circuitry, e.g., a qubit circuit, configured to at least temporarily store information in quantum mechanical state(s) of the circuitry. Quantum mechanical system 212 may comprise quantum mechanical system 100. The quantum mechanical state of quantum mechanical system 212 may be controlled by driving signals provided from quantum mechanical environment 211 and read out to quantum mechanical environment 211, for example as described with reference to qubit 101. Quantum mechanical environment 211 may be configured to control (e.g., by means of delivering information) quantum mechanical system 211, for example its quantum mechanical state. Controlling may for example include retrieving information on the state of quantum mechanical system 212, driving a qubit to a desired state, or resetting or cooling the qubit. Information may be therefore delivered between quantum mechanical environment 211 and quantum mechanical system 212.

Quantum mechanical system 212 may be (electrically and/or magnetically) coupled to quantum mechanical environment 211 at one or more coupling locations, for example by means of capacitive coupling. The coupling location(s) may be in relation to a physical appearance of quantum mechanical system 212, for example a qubit circuit. The coupling may be characterized with a set of parameters of quantum mechanical system 212 and quantum mechanical environment 211, as will be further described with reference to various example embodiments of quantum mechanical system 212 and quantum mechanicals environment 211. The set of parameters may affect the selection of coupling location(s) and/or coupling strength(s) in order to suppress certain state transition(s) of quantum mechanical system 212.

As described above, quantum mechanical system 212 may be capable of exhibiting transitions between a plurality of eigenstates of quantum mechanical system 212. Such transitions may be described with a transition matrix. In general, transition matrix element Mₖₗ may refer to an element of a transition matrix and may be associated with a probability amplitude of a transition between two eigenstates of quantum mechanical system 212, where k and l are indices of the two eigenstates. For example, transitions between lowest energy states e, g, f, may be denoted by transition matrix elements M_{eg}, M_{fg}, and M_{fe}. Elements of the transition matrix may be complex-valued. Square of the absolute value of such element may indicate strength of the transition. Elements of the transition matrix may be dependent on characteristics (e.g., coupling location(s) and other parameters) of quantum mechanical system 212 and quantum mechanical environment 211. However, for various example embodiments of quantum mechanical system 212 and quantum mechanical environment 212, it is possible to select a combination of the coupling location(s) and other parameters such that at least one of the transitions is strongly suppressed (e.g., the absolute value of respective transition matrix element is reduced, vanishes or is minimized, e.g., with respect to other transition matrix elements of the system) when delivering information between quantum mechanical system 212 and quantum mechanical environment 211, for example when driving the quantum mechanical state of quantum mechanical system 212 with driving signal(s) or reading out the quantum mechanical state of quantum mechanical system 212. Suppressing a transition amounts to filtering the noise spectrum. When a transition is suppressed, the corresponding frequency of the noise spectrum becomes filtered. Hence, suppressing a particular transition amounts to filtering a frequency of the noise spectrum. Suppression of a particular transition may be therefore used to implement band-stop filtering at the respective frequency.

In various example embodiments, quantum mechanical environment 211 may comprise a quantum circuit refrigerator (QCR), an Ohmic resistor, or a transmission line. QRC and Ohmic resistor are provided as examples of dissipative elements. Quantum mechanical system 2121 may comprise a multi-mode unimon (e.g., a two-mode unimon), a plurality of transmons (e.g., two transmons), a plurality of resonators (e.g., two resonators), a two-mode unimon with its intrinsic mode as read-out mode, or a QCR. A unimon may be configured to substantially operate as it would comprise a certain finite integer number of normal modes. Such a unimon substantially comprising more than one normal mode is referred here as a multi-mode unimon. For example, a two-mode unimon may be configured to substantially operate as it would comprise two modes, while influence of other normal modes to its operation may be practically negligible. Such a unimon comprising substantially two normal modes is referred here as a two-mode unimon.

Example embodiments of the present disclosure provide multiple realizations of coupling quantum electric circuits to the environment. Technical effects of filtering of the noise spectrum and improving reading out the state of the circuit (e.g., a qubit) are provided. Examples of different realizations and effects are organized below by the type of quantum mechanical environment 211 and quantum mechanical system 212 (e.g., the type of the electric circuit of the system).

### QCR as the Quantum Mechanical Environment

Quantum mechanical environment 211 may comprise a QCR. An example of a QCR 310 coupled with quantum mechanical system (QMS) 212 is illustrated in FIG. 3. A QCR may generally comprise a circuit assembly configured to cool quantum mechanical system 212, or at least one electrical circuit or device of the system. QCR 310 may be configured to provide a tunable dissipative environment for quantum mechanical system 211. QCR 310 may for example comprise at least one normal-metal-insulator-superconductor (NIS) tunnel junction 313 electrically connected to quantum mechanical system 212. QCR 310 may comprise at least one superconductive lead 314 for supplying a drive voltage (V_{QCR}) for NIS tunnel junction(s) 313. Quantum mechanical system 212 may be configured to be cooled when a suitable drive voltage is supplied to NIS tunnel junction(s) 313. In general, a QCR may comprise a dissipative element configured to (controllably) cool a quantum mechanical system.

QCR 310 may be formed on a suitable substrate or wafer 11, such as a semiconductor substrate or any other suitable material. By a semiconductor substrate is meant herein a substrate having a surface, at least part of which is formed of a semiconductor material, e.g., silicon. Such semiconductor material may form a layer lying on a body or a support portion of the semiconductor substrate, such body or support portion being formed of some other material. Alternatively, the semiconductor material may cover the entire thickness of the semiconductor substrate. The drive voltage (V_{QCR}) may be for example around 2 mV and the capacitance of NIS tunnel junction(s) 313 may be about 0.01-100 fF per a NIS tunnel junction.

The circuit assembly may further comprise necessary circuitry that brings different components into a metallurgical (and thus into an electrical) contact with each other. NIS tunnel junction 313 may be electrically coupled in series between the superconductive lead(s) 314 for supplying the drive voltage (V_{QCR}) and the quantum mechanical system 212.

Parameters of QCR 310 may be configured based on characteristics of quantum mechanical system 212, for example to enable desired cooling to be achieved. For example, energy difference hω₀/2π between two energy states of quantum mechanical system 212 may be in the range of h (0.3-300 GHZ), where h is the Planck constant. For example, in case of the system being a resonator, effective capacitance C of quantum mechanical system 212 may be given by C=π/(ρRₖω₀), where Rₖ is the von Klitzing constant, and p is the zero-temperature probability of a photon capture event in the course of a single-electron tunneling event which lies in the range of 0.00001-0.1. Further examples of suitable QCRs are provided in another patent application PCT/FI2016/050925 filed on Dec. 27, 2016, at the Finnish Patent and Registration Office as the Receiving office and published as WO 2017/115008 A1, which is incorporated herein by reference.

### Multi-Mode Unimon as the Quantum Mechanical System

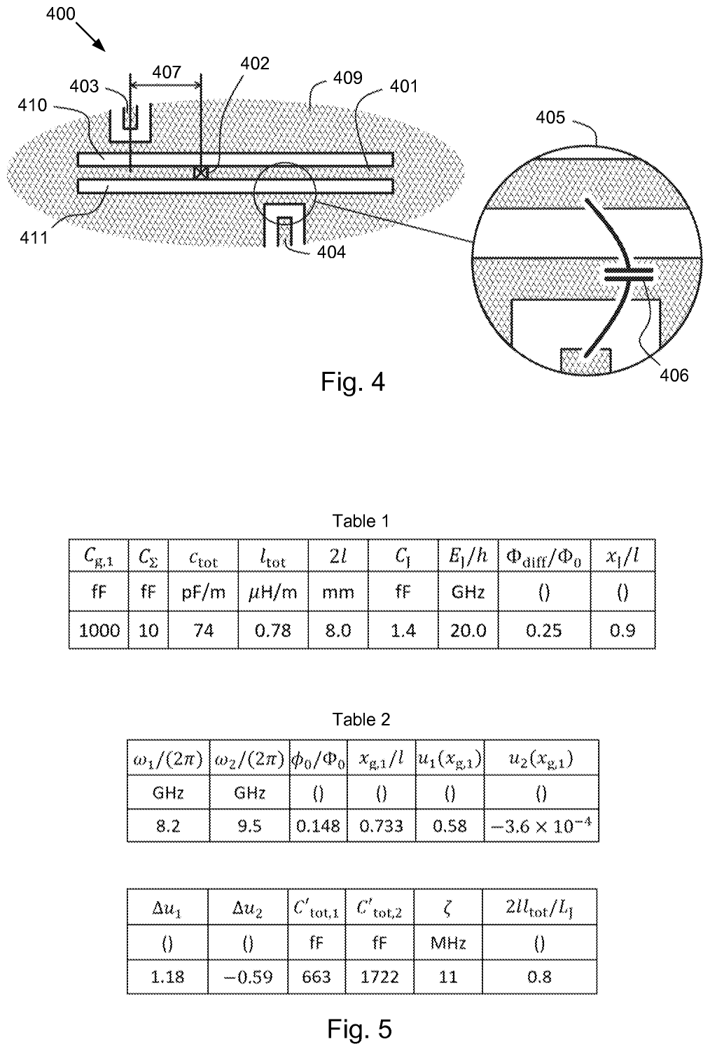

Quantum mechanical environment 211 may comprise a QCR and quantum mechanical system 212 may comprise a multi-mode unimon (e.g., a two-mode unimon), an example of which is illustrated in FIG. 4. A multi-mode unimon may be configured with a particular number (e.g., two) of modes such that the multi-mode unimon can be effectively described with this number of modes, even if the multi-mode unimon would also comprise other modes. Unimon qubit circuit 400, referred to also as ‘unimon’ may comprise superconducting patterns on a planar surface of an insulating substrate. Unimon 400 may comprise a coplanar waveguide 401 intercepted by a Josephson junction 402. Alternatively, a unimon comprising such a coplanar waveguide may comprise one or more one Josephson junctions in some other configuration (e.g., intercepting) with respect to coplanar waveguide 401.

Coplanar waveguide 401 may be also referred to as a centre superconductor. Coplanar waveguide 401 has a certain length between its two ends. This length may define the length of unimon 400. Unimon 400 may comprise a superconducting ground plane 409. Coplanar waveguide 401 (superconductor) may be galvanically connected to superconducting ground plane 409 at a pair of opposite ends. At the same time, coplanar waveguide 401 may be separated by (e.g., equal) gaps 410 and 411 from superconducting ground plane 409 on a second pair of opposite sides (i.e., top and bottom sides, as shown in FIG. 3). In this case, coplanar waveguide 401 may serve as a linear inductive-energy element of unimon 400. A non-linear inductive-energy element is represented by Josephson junction 402 embedded in coplanar waveguide 401 such that the circuit is free of superconducting islands.

In general, a superconducting island may refer to a Cooper-pair box connected via a tunnel junction to a the center superconductor. As another example, superconducting island would be formed between two Josephson junctions embedded in series within the center conductor. It should be noted that elements in FIG. 4 are not shown to scale for convenience. Furthermore, the shape of coplanar waveguide 401 and superconducting ground plane 409 are also illustrative and may be modified, depending on particular applications.

Josephson junction 402 may interrupt coplanar waveguide 401, as shown in FIG. 4. In one embodiment, Josephson junction 402 may be embedded in coplanar waveguide 401 such that a current flowing through coplanar waveguide 401 is equal on both sides of Josephson junction 402. In another embodiment, Josephson junction 402 may be centrally arranged in coplanar waveguide 401.

Quantum information processing system 210 may comprise coupling(s) for coupling unimon 400 to quantum mechanical environment 211, for example QCR 310. The coupling may be used for example for provide driving signals to unimon 400 or for reading out the qubit state of unimon 400. In the example of FIG. 4, there are two such couplings, each having the physical form of a superconductive pattern 403 or 404, the end of which reaches close to coplanar waveguide 401 at some point (coupling location) along its length. The partial enlargement 405 shows schematically how a capacitive coupling 406 can be made to the coplanar waveguide 401 for capacitive coupling between unimon 400 and quantum mechanical environment 211. It is noted that even though two coupling locations are illustrated in FIG. 4, it is possible to have other number of coupling locations. For example, in some example embodiments a single coupling location (e.g., one of two couplings of FIG. 4) may be used.

FIG. 4 shows the distance 407 between Josephson junction 402 and the point of closest distance from the end of the superconductive pattern 403 and coplanar waveguide 401. The respective capacitive coupling can be considered to be made at said point. In case of two coupling locations, this point may be closer to the left end of the coplanar waveguide 401 than the respective point for the other superconductive pattern 404 is to the right end of coplanar waveguide 401. Additionally, the distance between the coupling point of first superconductive pattern 403 and Josephson junction 402 may be different than the distance between the coupling point of second superconductive pattern 404 and Josephson junction 402. The definitions of distances can be made in various ways; for the viewpoint here, it is only important that—as mentioned above—the coupling of unimon 400 to quantum mechanical environment 211 may be made at one or more (different) locations along the length of coplanar waveguide 401. Further examples of a suitable unimon for use as quantum mechanical system 212 are described in a co-pending patent application of the applicant filed on Sep. 30, 2022, as PCT/FI2022/050655 at the Finnish Patent and Registration Office as the Receiving Office, which is incorporated herein by reference.

Under the approximation that a “two-mode” unimon comprises substantially two modes, also referred to as normal modes, its Hamiltonian under external magnetic field and capacitive coupling to one or more quantum mechanical environments 211, also referred to as giant environments, at total of N points may be expressed as

$$\begin{matrix}\hat{H} \approx {\sum }_{m = 1}^{2} ℏ {ω}_{m} {\hat{a}}_{m}^{†} {\hat{a}}_{m} \\ + \frac{1}{2} {( \frac{2 π}{{Φ}_{0}} )}^{3} {E}_{J} sin ( \frac{2 π {ϕ}_{0}}{{Φ}_{0}} ) {d}_{1}^{2} {d}_{2} ( {\hat{a}}_{1}^{†2} {\hat{a}}_{2} + {\hat{a}}_{1}^{2} {\hat{a}}_{2}^{†} ) \\ - \frac{1}{4} {( \frac{2 π}{{Φ}_{0}} )}^{4} {E}_{J} cos ( \frac{2 π {ϕ}_{0}}{{Φ}_{0}} ) {\sum }_{m = 1}^{2} {d}_{m}^{4} ( {\hat{a}}_{m}^{†} {\hat{a}}_{m} {\hat{a}}_{m}^{†} {\hat{a}}_{m} + {\hat{a}}_{m}^{†} {\hat{a}}_{m} ) \\ - \frac{1}{2} {( \frac{2 π}{{Φ}_{0}} )}^{4} {E}_{J} cos ( \frac{2 π {ϕ}_{0}}{{Φ}_{0}} ) {d}_{1}^{2} {d}_{2}^{2} ( 2 {\hat{a}}_{1}^{†} {\hat{a}}_{1} {\hat{a}}_{2}^{†} {\hat{a}}_{2} + {\hat{a}}_{1}^{†} {\hat{a}}_{1} + {\hat{a}}_{2}^{†} {\hat{a}}_{2} ) \\ - \frac{1}{6} {( \frac{2 π}{{Φ}_{0}} )}^{4} {E}_{J} cos ( \frac{2 π {ϕ}_{0}}{{Φ}_{0}} ) {d}_{1}^{3} {d}_{2} ( {\hat{a}}_{2} {\hat{a}}_{1}^{† 3} + 3 ( {\hat{a}}_{1}^{†} {\hat{a}}_{2} + {\hat{a}}_{1} {\hat{a}}_{2}^{†} ) {\hat{a}}_{1}^{†} {\hat{a}}_{1} + \\ 3 {\hat{a}}_{1}^{†} {\hat{a}}_{2} + {\hat{a}}_{2}^{†} {\hat{a}}_{1}^{3} \\ - \frac{1}{2} {( \frac{2 π}{{Φ}_{0}} )}^{4} {E}_{J} cos ( \frac{2 π {ϕ}_{0}}{{Φ}_{0}} ) {d}_{1} {d}_{2}^{3} ( ( {\hat{a}}_{2}^{†} {\hat{a}}_{1} + {\hat{a}}_{z} {\hat{a}}_{1}^{†} ) {\hat{a}}_{2}^{†} {\hat{a}}_{2} + {\hat{a}}_{2}^{†} {\hat{a}}_{1} ) ,\end{matrix} \qquad ( 1 )$$

$${d}_{m} = \sqrt{\frac{ℏ}{2 {C}_{tot , m}^{′} {ω}_{m}}} , \qquad ( 2 )$$

$${C}_{t o t , m}^{′} = [ 2 {c}_{t o t} l + {C}_{J} + {\sum }_{n = 1}^{N} {{C}_{g , n} ( {u}_{m} ( {x}_{g , n} ) )}^{2} ] / {( Δ {u}_{m} )}^{2} , \qquad ( 3 )$$

where ℏ is the reduced Planck constant, ωₘ is the angular frequency of the linearized m-th mode,

$${\hat{a}}_{m}^{†}$$

and âₘ are the creation and annihilation operators of the m-th mode, Φ₀ is the flux quantum, E_{J} is the Josephson energy, φ₀ is the coefficient of the DC (direct current) mode of the unimon in units of flux, cₜₒₜ is the total capacitance per unit length of the unimon, 2l is the length of the unimon (e.g., length of coplanar waveguide 401), C_{J} is the capacitance of the Josephson junction of the unimon, C_{g,n} is the capacitance of the n-th coupling point of quantum mechanical environment 211 (in this example a QCR) to quantum mechanical system 212 (in this example a unimon), uₘ(x_{g,n}) is the envelope function of the m-th normal mode of the unimon at the n-th coupling point x_{g,n}, and Δuₘ denotes the discontinuity of the envelope function of the m-th mode of the unimon across the junction.

Consider coupling the unimon to a quantum-circuit refrigerator (QCR) at one point (N=1). The transition matrix elements read

$${M}_{{kk}^{′}} = 〈 {k}^{′} \vert {e}^{- i \frac{e}{ℏ} α {\hat{ϕ}}_{1}} \vert k 〉 , \qquad ( 4 )$$

where |k [symbol] is the eigenstate of the two-mode unimon with the label k, e is the elementary charge, α=C_{g,1}/(C_{g,1}+C_{Σ}) with C_{Σ} being the total junction capacitance of the QCR, and

$${\hat{ϕ}}_{1} = {\sum }_{m = 1}^{2} \frac{{u}_{m} ( {x}_{g , 1} )}{Δ {u}_{m}} \sqrt{\frac{ℏ}{2 {C}_{tot , m}^{′} {ω}_{m}}} ( {\hat{a}}_{m}^{†} + {\hat{a}}_{m} ) \qquad ( 5 )$$

$$\text{=:} {\sum }_{m = 1}^{2} {d}_{m} ( {\hat{a}}_{m}^{†} + {\hat{a}}_{m} ) . \qquad ( 6 )$$

It can be shown that the three lowest eigenstates of the bare two-mode unimon are

$$\vert g 〉 = \vert 00 〉 , \qquad ( 7 )$$

$$\vert e 〉 = \frac{1}{\sqrt{2 {Δ}^{2} + 2 {ζ}^{2} - 2 Δ \sqrt{{Δ}^{2} + {ζ}^{2}}}} [ ( Δ - \sqrt{{Δ}^{2} + {ζ}^{2}} ) \vert 10 〉 + ζ \vert 01 〉 ] \qquad ( 8 )$$

$$\text{=:} {c}_{e , 10} \vert 10 〉 + {c}_{e , 01} \vert 01 〉 , \qquad ( 9 )$$

$$\vert f 〉 = \frac{1}{\sqrt{2 {Δ}^{2} + 2 {ζ}^{2} + 2 Δ \sqrt{{Δ}^{2} + {ζ}^{2}}}} [ ( Δ + \sqrt{{Δ}^{2} + {ζ}^{2}} ) \vert 10 〉 + ζ \vert 01 〉 ] \qquad ( 10 )$$

$$\text{=:} {c}_{f , 10} \vert 10 〉 + {c}_{f , 01} \vert 01 〉 , \qquad ( 11 )$$

where |kl [symbol] denotes the number state of the two-mode unimon with k and l excitations in the first and second mode, respectively, and

$$Δ = {ω}_{2}^{′} - {ω}_{1}^{′} \qquad ( 12 )$$

$${ω}_{m}^{′} = {ω}_{m} - \frac{ℏ}{16} {( \frac{2 π}{{Φ}_{0}} )}^{4} {E}_{J} cos ( \frac{2 π {ϕ}_{0}}{{Φ}_{0}} ) [ {( {C}_{t o t , m}^{′} {ω}_{m} )}^{- 2} + 2 {( {C}_{t o t , 1}^{′} {ω}_{1} {C}_{tot , 2}^{′} {ω}_{2} )}^{- 1} ] , \qquad ( 13 )$$

$$( 14 )$$

$$ζ = \frac{ℏ}{4} {( \frac{2 π}{{Φ}_{0}} )}^{4} {E}_{J} cos ( \frac{2 π {ϕ}_{0}}{{Φ}_{0}} ) {( {C}_{t o t , 1}^{′} {ω}_{1} {C}_{tot , 2}^{′} {ω}_{2} )}^{- 1 / 2} [ {( {C}_{t ot , 1}^{′} {ω}_{1} )}^{- 1} + {( {C}_{t o t , 2}^{′} {ω}_{2} )}^{- 1} ] .$$

The transition matrix elements between the three lowest energy states (e, g, f) read

$${M}_{eg} = 〈 g \vert {e}^{- i \frac{e}{ℏ} α {\hat{ϕ}}_{1}} \vert e 〉 = 〈 00 \vert {e}^{- i \frac{e}{ℏ} α ( {d}_{1} {\hat{a}}_{1}^{†} + {d}_{1} {\hat{a}}_{1} + {d}_{2} {\hat{a}}_{2}^{†} + {d}_{2} {\hat{a}}_{2} )} ( {c}_{e , 10} \vert 10 〉 + {c}_{e , 01} \vert 01 〉 ) = 〈 00 \vert {e}^{- i \frac{e}{ℏ} α {d}_{1} ( {\hat{a}}_{1}^{†} + {\hat{a}}_{1} )} {e}^{- i \frac{e}{ℏ} α {d}_{2} ( {\hat{a}}_{2}^{†} + {\hat{a}}_{2} )} ( {c}_{e , 10} \vert 10 〉 + {c}_{e , 01} \vert 01 〉 ) = 〈 00 \vert {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- \frac{{( \frac{e}{ℏ} α {d}_{1} )}^{2}}{2}} {e}^{- i \frac{e}{ℏ} α {d}_{2} {\hat{a}}_{2}^{†}} {e}^{- i \frac{e}{ℏ} α {d}_{2} {\hat{a}}_{2}} {e}^{- \frac{{( \frac{e}{ℏ} α {d}_{2} )}^{2}}{2}} ( {c}_{e , 10} \vert 10 〉 + {c}_{e , 01} \vert 01 〉 ) = {e}^{- \frac{{( \frac{e}{ℏ} α )}^{2} ( {d}_{1}^{2} + {d}_{2}^{2} )}{2}} {c}_{e , 10} 〈 00 \vert {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- i \frac{e}{ℏ} α {d}_{2} {\hat{a}}_{2}^{†}} {e}^{- i \frac{e}{ℏ} α {d}_{2} {\hat{a}}_{2}} \vert 10 〉 + {e}^{- \frac{{( \frac{e}{ℏ} α )}^{2} ( {d}_{1}^{2} + {d}_{2}^{2} )}{2}} {c}_{e , 01} 〈 00 \vert {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- i \frac{e}{ℏ} α {d}_{2} {\hat{a}}_{2}^{†}} {e}^{- i \frac{e}{ℏ} α {d}_{2} {\hat{a}}_{2}} \vert 01 〉 = {e}^{- {( \frac{e}{ℏ} α )}^{2} ( {d}_{1}^{2} + {d}_{2}^{2} ) / 2} {c}_{e , 10} 〈 00 \vert {\sum }_{n , n ′ = 0}^{∞} \frac{1}{n ! {n}^{′} !} {( - i \frac{e}{ℏ} α {d}_{1} )}^{n + n ′} {( {\hat{a}}_{1}^{†} )}^{n} {\hat{a}}_{1}^{n ′} \vert 10 〉 + {e}^{- {( \frac{e}{ℏ} α )}^{2} ( {d}_{1}^{2} + {d}_{2}^{2} ) / 2} {c}_{e , 01} 〈 00 \vert {\sum }_{n , n ′ = 0}^{∞} \frac{1}{n ! {n}^{′} !} {( - i \frac{e}{ℏ} α {d}_{2} )}^{n + n ′} {( {\hat{a}}_{2}^{†} )}^{n} {\hat{a}}_{2}^{n ′} \vert 01 〉 = - i \frac{e}{ℏ} α {d}_{1} {e}^{- {( \frac{e}{ℏ} α )}^{2} ( {d}_{1}^{2} + {d}_{2}^{2} ) / 2} {c}_{e , 10} - i \frac{e}{ℏ} α {d}_{2} {e}^{- {( \frac{e}{ℏ} α )}^{2} ( {d}_{1}^{2} + {d}_{2}^{2} ) / 2} {c}_{e , 01} = - i \frac{e}{ℏ} α {e}^{- {( \frac{e}{ℏ} α )}^{2} + ( {d}_{1}^{2} + {d}_{2}^{2} ) / 2} ( {d}_{1} {c}_{e , 10} + {d}_{2} {c}_{e , 01} ) , \qquad ( 15 )$$

$${M}_{fg} = - i \frac{e}{ℏ} α {e}^{- {( \frac{e}{ℏ} α )}^{2} ( {d}_{1}^{2} + {d}_{2}^{2} ) / 2} ( {d}_{1} {c}_{f , 10} + {d}_{2} {c}_{f , 01} ) , \qquad ( 16 )$$

$${M}_{fe} = {e}^{- \frac{{( \frac{e}{ℏ} α )}^{2} ( {d}_{1}^{2} + {d}_{2}^{2} )}{2}} ( {c}_{e , 10}^{*} 〈 10 \vert + {c}_{e , 01}^{*} 〈 01 \vert ) {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- i \frac{e}{ℏ} α {d}_{2} {\hat{a}}_{2}^{†}} {e}^{- i \frac{e}{ℏ} α {d}_{2} {\hat{a}}_{2}} ( {c}_{f , 10} \vert 10 + {c}_{f , 01} \vert 01 〉 ) = {c}_{e , 10}^{*} {c}_{f , 10} {e}^{- \frac{{( \frac{e}{ℏ} α )}^{2} ( {d}_{1}^{2} + {d}_{2}^{2} )}{2}} 〈 10 \vert {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- i \frac{e}{ℏ} α {d}_{2} {\hat{a}}_{2}^{†}} {e}^{- i \frac{e}{ℏ} α {d}_{2} {\hat{a}}_{2}} \vert 10 〉 + {c}_{e , 10}^{*} {c}_{f , 01} {e}^{- \frac{{( \frac{e}{ℏ} α )}^{2} ( {d}_{1}^{2} + {d}_{2}^{2} )}{2}} 〈 10 \vert {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- i \frac{e}{ℏ} α {d}_{2} {\hat{a}}_{2}^{†}} {e}^{- i \frac{e}{ℏ} α {d}_{2} {\hat{a}}_{2}} \vert 01 〉 + {c}_{e , 01}^{*} {c}_{f , 10} {e}^{- \frac{{( \frac{e}{ℏ} α )}^{2} ( {d}_{1}^{2} + {d}_{2}^{2} )}{2}} 〈 01 \vert {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- i \frac{e}{ℏ} α {d}_{2} {\hat{a}}_{2}^{†}} {e}^{- i \frac{e}{ℏ} α {d}_{2} {\hat{a}}_{2}} \vert 10 〉 + {c}_{e , 01}^{*} {c}_{f , 01} {e}^{- \frac{{( \frac{e}{ℏ} α )}^{2} ( {d}_{1}^{2} + {d}_{2}^{2} )}{2}} 〈 01 \vert {e}^{- i \frac{e}{ℏ} α {d}_{1} {\hat{a}}_{1}^{†}} {e}^{- i \frac{e}{ℏ} α {d}_{1} {\hat{a}}_{1}} {e}^{- i \frac{e}{ℏ} α {d}_{2} {\hat{a}}_{2}^{†}} {e}^{- i \frac{e}{ℏ} α {d}_{2} {\hat{a}}_{2}} \vert 01 = {c}_{e , 10}^{*} {c}_{f , 10} {e}^{- \frac{{( \frac{e}{ℏ} α )}^{2} ( {d}_{1}^{2} + {d}_{2}^{2} )}{2}} [ 1 - {( \frac{e}{ℏ} α {d}_{1} )}^{2} ] - {c}_{e , 10}^{*} {c}_{f , 01} {{e}^{- \frac{{( \frac{e}{ℏ} α )}^{2} ( {d}_{1}^{2} + {d}_{2}^{2} )}{2}} ( \frac{e}{ℏ} α )}^{2} {d}_{1} {d}_{2} - {c}_{e , 01}^{*} {c}_{f , 10} {{e}^{- \frac{{( \frac{e}{ℏ} α )}^{2} ( {d}_{1}^{2} + {d}_{2}^{2} )}{2}} ( \frac{e}{ℏ} α )}^{2} {d}_{1} {d}_{2} + {c}_{e , 01}^{*} {c}_{f , 01} {e}^{- \frac{{( \frac{e}{ℏ} α )}^{2} ( {d}_{1}^{2} + {d}_{2}^{2} )}{2}} [ 1 - {( \frac{e}{ℏ} α {d}_{2} )}^{2} ] = {{e}^{- \frac{{( \frac{e}{ℏ} α )}^{2} ( {d}_{1}^{2} + {d}_{2}^{2} )}{2}} ( \frac{e}{ℏ} α )}^{2} \{ [ {( \frac{ℏ}{e α} )}^{2} - {d}_{1}^{2} ] {c}_{e , 10} {c}_{f , 10} + [ {( \frac{ℏ}{e α} )}^{2} - {d}_{2}^{2} ] {c}_{e , 01} {c}_{f , 01} - {d}_{1} {d}_{2} ( {c}_{e , 10} {c}_{f , 01} + {c}_{e , 01} {c}_{f , 10} ) \} , \qquad ( 17 )$$

where we have used the property that c_{e,10}, c_{e,01}, c_{f,10}, c_{f,01}∈ [symbol] . Note that we can completely suppress the e↔g transition by numerically solving the equation M_{eg}=0 for the required position of the unimon-QCR coupling at a single coupling location x_{g,1}. Hence, element M_{eg} of the transition matrix may be minimized by forcing it to zero. In general, suppression of the transition in question may be achieved if the value of the respective element of the transition matrix is forced to a lower (zero or non-zero) value. It is therefore possible to suppress certain transition(s) by using a properly selected single coupling location between a QCR and a two-mode unimon. The above equations may be generalized to a multi-mode qubit having more than two modes.

Note that the equations described herein, such as for example as demonstrated for QCR and two-mode unimon above, are applicable when coupling the system in question to a quantum mechanical environment capable of exhibiting a continuous spectrum of modes, in other words, modes from a continuous spectrum. Examples of such systems include the two-mode unimon, but also a combination of two or more transmon qubit circuits, a combination of two or more resonator circuits, or a QCR, as will be further described below.

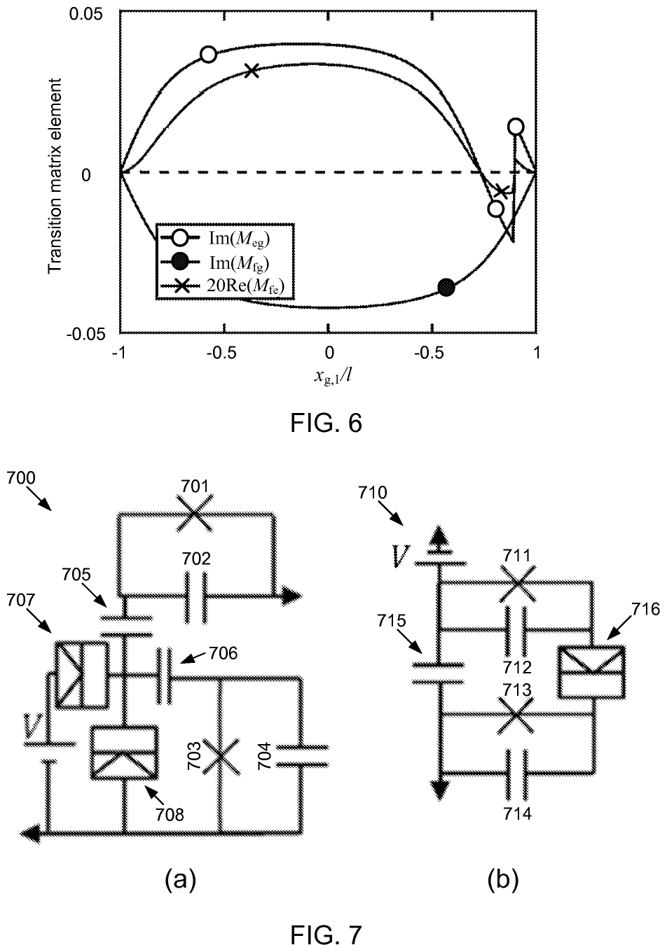

To theoretically demonstrate feasibility of this example embodiment, we iteratively evaluate Equation (15) to determine its root in x_{g,1}, given the set of parameters of Table 1 of FIG. 5. Values of parameters calculated based on parameter values of Table 1 are provided in Table 2 of FIG. 5. Determining the root of Equation (15) yields approximately x_{g,1}=0.733l, which is therefore the coupling location that in theory completely suppresses the e↔g transition for the set of parameters of Table 1 of FIG. 5. Note that for the given parameters also M_{fe}=0, as illustrated in FIG. 6, which shows the transition matrix elements as functions of the scaled QCR-coupling location x_{g,1}/l.

Parameters in Table 2 may be calculated using formulas and equations given in the referred patent application PCT/FI2022/050655, for example as provided in FIG. 21 of PCT/FI2022/050655. For example, Φ₀ may be obtained as a solution of the fifth equation of that figure. Wavenumbers kₘ of that figure may be obtained as solutions for the sixth equation of that figure. Normal modes ωₘ may be obtained by ωₘ=kₘ\sqrt{cₜₒₜlₜₒₜ}. Note that

$$Δ {u}_{m} = {u}_{m} ( {x}_{J}^{+} ) - {u}_{m} ( {x}_{J}^{-} ) ,$$

where

$${x}_{J}^{+} and {x}_{J}^{-}$$

refer to the mode envelope functions of the m-th mode at the location of the Josephson junction on its right- and left-hand-side, respectively.

The formula for the coefficients Aₘ may be derived using the following orthogonality relation:

$$〈 {u}_{m} , {u}_{m} 〉 = {\int }_{- l}^{l} {c}_{tot} {u}_{m}^{2} ( x ) dx + {{C}_{J} ( Δ {u}_{m} )}^{2} + {C}_{g , 1} {u}_{m}^{2} ( {x}_{g , 1} ) = {C}_{tot , m} , \qquad ( 18 )$$

$$where {C}_{tot , m} = 2 {c}_{tot} l + {C}_{J} + {C}_{g , 1} {u}_{m}^{2} ( {x}_{g , 1} ) , as$$

$$2 {c}_{tot} l + {C}_{J} = {\int }_{- l}^{{x}_{J}} {c}_{tot} {u}_{m}^{2} ( x ) dx + {\int }_{{x}_{J}}^{l} {c}_{tot} {u}_{m}^{2} ( x ) dx + {{C}_{J} ( Δ {u}_{m} )}^{2} = {c}_{tot} {A}_{m}^{2} {\int }_{- l}^{{x}_{J}} {sin}^{2} ( {k}_{m} ( x + l ) ) dx + {c}_{tot} {A}_{m}^{2} \frac{{cos}^{2} ( {k}_{m} ( {x}_{J} + l ) )}{{cos}^{2} ( {k}_{m} ( {x}_{J} - l ) )} {\int }_{{x}_{J}}^{l} {sin}^{2} ( {k}_{m} ( x - l ) ) dx + {C}_{J} {{A}_{m}^{2} [ \frac{cos ( {k}_{m} ( {x}_{J} + l ) )}{cos ( {k}_{m} ( {x}_{J} - l ) )} sin ( {k}_{m} ( {x}_{J} - l ) ) - sin ( {k}_{m} ( {x}_{J} + l ) ) ]}^{2} = \frac{{c}_{tot} {A}_{m}^{2}}{2} [ {x}_{J} + l - \frac{1}{2 {k}_{m}} sin ( 2 {k}_{m} ( {x}_{J} + l ) ) ] + \frac{{c}_{tot} {A}_{m}^{2}}{2} \frac{{cos}^{2} ( {k}_{m} ( {x}_{J} + l ) )}{{cos}^{2} ( {k}_{m} ( {x}_{J} - l ) )} [ - {x}_{J} + l + \frac{1}{2 {k}_{m}} sin ( 2 {k}_{m} ( {x}_{J} - l ) ) ] + {C}_{J} {{A}_{m}^{2} [ \frac{cos ( {k}_{m} ( {x}_{J} + l ) )}{cos ( {k}_{m} ( {x}_{J} - l ) )} sin ( {k}_{m} ( {x}_{J} - l ) ) - sin ( {k}_{m} ( {x}_{J} + l ) ) ]}^{2} ⇒ 2 ( 2 {c}_{tot} l + {C}_{J} ) {cos}^{2} ( {k}_{m} ( {x}_{J} - l ) ) = {c}_{tot} {A}_{m}^{2} {cos}^{2} ( {k}_{m} ( {x}_{J} - l ) ) [ {x}_{J} + l - \frac{1}{2 {k}_{m}} sin ( 2 {k}_{m} ( {x}_{J} + l ) ) ] + {c}_{tot} {A}_{m}^{2} {cos}^{2} ( {k}_{m} ( {x}_{J} + l ) ) [ - {x}_{J} + l + \frac{1}{2 {k}_{m}} sin ( 2 {k}_{m} ( {x}_{J} - l ) ) ] + 2 {C}_{J} {{A}_{m}^{2} [ cos ( {k}_{m} ( {x}_{J} + l ) ) sin ( {k}_{m} ( {x}_{J} - l ) ) - cos ( {k}_{m} ( {x}_{J} - l ) ) sin ( {k}_{m} ( {x}_{J} + l ) ) ]}^{2} = {c}_{tot} {A}_{m}^{2} [ ( {x}_{J} + l ) {cos}^{2} ( {k}_{m} ( {x}_{J} - l ) ) + ( l - {x}_{J} ) {cos}^{2} ( {k}_{m} ( {x}_{J} + l ) ) ] - {c}_{tot} {A}_{m}^{2} {k}_{m}^{- 1} sin ( 2 {k}_{m} l ) cos ( {k}_{m} ( {x}_{J} + l ) ) cos ( {k}_{m} ( {x}_{J} - l ) ) + 2 {C}_{J} {A}_{m}^{2} {sin}^{2} ( 2 {k}_{m} l ) ⇒ {A}_{m} = \sqrt{\frac{4 {c}_{tot} l + 2 {C}_{J}}{{D}_{m}}} cos ( {k}_{m} ( {x}_{J} - l ) ) , \qquad ( 19 )$$

$${D}_{m} = {c}_{tot} [ ( {x}_{J} + l ) {cos}^{2} ( {k}_{m} ( {x}_{J} - l ) ) + ( l - {x}_{J} ) {cos}^{2} ( {k}_{m} ( {x}_{J} + l ) ) ] - {c}_{tot} {k}_{m}^{- 1} sin ( 2 {k}_{m} l ) cos ( {k}_{m} ( {x}_{J} + l ) ) cos ( {k}_{m} ( {x}_{J} - l ) ) + 2 {C}_{J} {sin}^{2} ( 2 {k}_{m} l ) , \qquad ( 20 )$$

where the envelope functions uₘ(x) are given by

$${u}_{m} ( x ) = \{ \begin{matrix}{A}_{m} sin ( {k}_{m} ( x + l ) ) , & for x ∈ [ - l , {x}_{J} ) , \\ {A}_{m} {B}_{m} sin ( {k}_{m} ( x - l ) ) , & for x ∈ ( {x}_{J} , l ] ,\end{matrix} \qquad ( 21 )$$

$${B}_{m} = \frac{cos ( {k}_{m} ( {x}_{J} + l ) )}{cos ( {k}_{m} ( {x}_{J} - l ) )} , \qquad ( 22 )$$

$$Δ {u}_{m} = {u}_{m} ( {x}_{J}^{+} ) - {u}_{m} ( {x}_{J}^{-} ) . \qquad ( 23 )$$

It is therefore possible to find a single coupling location that suppresses the desired transition(s) when coupling a multi-mode unimon to a QCR.

A multi-mode unimon may be also coupled to at least one quantum mechanical environment 211, e.g., a transmission line, via multiple coupling locations. This enables, e.g., to perform a more complex readout, for example by driving the e-f or e-h transition using at least one drive line coupled to their respective coupling location and reading out the state of the unimon based on photons absorbed to an engineered quantum environment through at least one coupling location as a consequence of a relaxation process causing h-e, h-f, or f-e transition, where e is the first excited state and f and h are the second and third excited states, respectively. The second and third excited states may have the second and third lowest energies among the excited states of the multi-mode unimon (cf. states |2> and |3> of FIG. 1). In such a case, changing the state of the multi-mode unimon operating as quantum mechanical system may comprise driving the state of the quantum mechanical system to the second or third excited state and reading out its state based on a relaxing transition from the second or third excited state to a lower excited state of the multi-mode unimon.

### Transmons as the Quantum Mechanical System

Quantum mechanical environment may comprise a QCR and quantum mechanical system 212 may comprise a plurality of transmon qubit circuits. Examples of such quantum information processing systems in case of two transmons are illustrated in FIG. 7. When two transmons are coupled to quantum mechanical environment 211 through the sum or difference of their charge operators, it is possible to suppress certain state transition(s), as described with reference to the two example circuits of FIG. 7.

FIG. 7a illustrates an example of an electric circuit 700 for implementing sum of charge coupling of two transmons to a QCR. Circuit 700 may comprise a first Josephson junction 701 coupled in parallel with first capacitor 702. The combination of Josephson junction 701 and capacitor 702 may be configured to operate as a first transmon qubit circuit. Circuit 700 may comprise a second Josephson junction 703 coupled in parallel with a second capacitor 704. The combination of Josephson junction 703 and capacitor 704 may be configured to operate as a second transmon qubit circuit. The first and second transmon qubit circuits may be capacitively coupled via coupling capacitors 705, 706 to a QCR, comprising in this example two NIS tunnel junctions 707, 708 coupled in parallel to each other and to a common voltage source. The first and second transmon qubit circuits may be identical. The QCR may be biased with the direct current (DC) voltage V. Capacitances of coupling capacitors 705, 706 may be equal. Coupling locations of the transmons to the QCR, e.g., connection points of capacitors 705, 706 with respect to other components of the circuit, may be selected such that the transmons are coupled to the QCR (e.g., a normal metal island of a single QRC) by their sum of charge operator. Circuit 700 provides an example of such coupling locations. Furthermore, capacitances of coupling capacitors 705, 706 may be substantially equal. The set of parameters characterizing the coupling of the transmon qubits to the QCR may therefore comprise substantially equal capacitances for coupling capacitors 705, 706. A normal metal island of a QCR may comprise the region between two NIS junctions of the QCR, for example as described in “Theory of quantum-circuit refrigeration by photon-assisted electron tunneling” (https://arxiv.org/pdf/1706.07188.pdf) by Matti Silveri, Hermann Grabert, Shumpei Masuda, Kuan Yen Tan, and Mikko Möttönen. Quantum mechanical system 212 may be coupled to the normal metal island of a QCR configured to operate as quantum mechanicals environment 211.

In case of two identical transmon qubits, this scenario nullifies the transition matrix element between the Bell state |Ψ⁻)=(|eg [symbol] −|ge [symbol] )\sqrt{2} and the two-qubit ground state |Ψ^{g} [symbol] =|gg [symbol] . Note that this scenario may be seen as analogous to that described above for the two-mode unimon coupled to QCR at a single coupling location.

The complete suppression of the |Ψ⁻)↔|Ψ^{g}) transition can be understood by calculating the transition matrix element in accordance with Equation (4) as follows:

$${M}_{- , g} = 〈 {Ψ}^{g} \vert {e}^{- i \frac{e}{ℏ} α {\hat{ϕ}}_{1}} \vert {Ψ}^{-} 〉 = \frac{1}{\sqrt{2}} 〈 gg \vert {e}^{- i \frac{e}{ℏ} α d ( {\hat{a}}_{1}^{†} + {\hat{a}}_{1} + {\hat{a}}_{2}^{†} + {\hat{a}}_{2} )} ( \vert eg 〉 - \vert ge 〉 ) = \frac{1}{\sqrt{2}} 〈 gg \vert {e}^{- i \frac{e}{ℏ} α d ( {\hat{a}}_{1}^{†} + {\hat{a}}_{1} )} {e}^{- i \frac{e}{ℏ} α d ( {\hat{a}}_{2}^{†} + {\hat{a}}_{2} )} ( \vert eg 〉 - \vert ge 〉 ) = \frac{{e}^{- {( \frac{e}{ℏ} α d )}^{2}}}{\sqrt{2}} 〈 gg \vert {e}^{- i \frac{e}{ℏ} α d {\hat{a}}_{1}^{†}} {e}^{- i \frac{e}{ℏ} α d {\hat{a}}_{1}} {e}^{- i \frac{e}{ℏ} α d {\hat{a}}_{2}^{†}} {e}^{- i \frac{e}{ℏ} α d {\hat{a}}_{2}} ( \vert eg 〉 - \vert ge 〉 ) = \frac{{e}^{- {( \frac{e}{ℏ} α d )}^{2}}}{\sqrt{2}} ( 〈 gg \vert {e}^{- i \frac{e}{ℏ} α d {\hat{a}}_{1}^{†}} {e}^{- i \frac{e}{ℏ} α d {\hat{a}}_{1}} \vert eg 〉 - 〈 gg \vert {e}^{- i \frac{e}{ℏ} α d {\hat{a}}_{2}^{†}} {e}^{- i \frac{e}{ℏ} α d {\hat{a}}_{2}} \vert ge 〉 ) = \frac{{e}^{- {( \frac{e}{ℏ} α d )}^{2}}}{\sqrt{2}} ( - i \frac{e}{ℏ} α d ) - \frac{{e}^{- {( \frac{e}{ℏ} α d )}^{2}}}{\sqrt{2}} ( - i \frac{e}{ℏ} α d ) = 0 , \qquad ( 24 )$$

where

$$d = {( 2 {E}_{C , 1} / {E}_{J , 1} )}^{\frac{1}{4}} = {( 2 {E}_{C , 2} / {E}_{J , 2} )}^{\frac{1}{4}} ,$$

and E_{C,j} and E_{J,j} are the charging energy and the Josephson energy of the j-th transmon qubit, respectively. A two-transmon circuit with suitable coupling locations may be therefore configured to transmon suppress certain state transition(s) via the sum of charge operator of the transmons. Sum of charge operators may comprise an operator that is dependent on (e.g., proportional to) the sum of the creation and annihilation operators of the qubits.

FIG. 7b illustrates an example of an electric circuit 710 for implementing “difference of charge” coupling of two transmons to a QCR through the difference between their respective charge operators. Circuit 710 may comprise a first Josephson's junction 711 coupled in parallel with first capacitor 712. The combination of Josephson junction 711 and capacitor 712 may be configured to operate as a first transmon qubit circuit. Circuit 710 may comprise a second Josephson junction 713 coupled in parallel with a second capacitor 714. The combination of Josephson junction 713 and capacitor 714 may be configured to operate as a second transmon qubit circuit. The first and second transmon qubit circuits may be capacitively coupled to each other by capacitor 715. The first and second transmon qubit circuits may be coupled a QCR comprising a NIS tunnel junction 716. The first and second transmon qubit circuits may be identical. DC voltage V may be supplied from a voltage source to the first transmon qubit and capacitor 715. Coupling locations of the transmons to the QCR may be therefore selected such that the transmons are coupled to the QCR by the difference of their charge operators. Difference of charge operators may comprise an operator that is dependent on (e.g., proportional to) the difference of the creation and annihilation operators of the qubits.

Suppression of certain state transition(s) may be obtained by coupling the two transmons to the QCR through the difference of their charge operators. In case of two identical transmon qubits, this scenario nullifies the transition matrix element between the Bell state |Ψ⁺ [symbol] =(|eg [symbol] )+|ge [symbol] )\sqrt{2} and the two-qubit ground state |Ψ^{g} [symbol] =|gg [symbol] . This scenario may be again seen as analogous to that described above for a two-mode unimon coupled to a QCR at a single coupling location.

The complete suppression of the |Ψ⁺)↔|Ψ^{g} [symbol] transition can be understood by calculating the transition matrix element in accordance with Equation (4) as follows:

$${M}_{+ , g} = 〈 {Ψ}^{g} \vert {e}^{- i \frac{e}{ℏ} α {\hat{ϕ}}_{1}} \vert {Ψ}^{+} 〉 = \frac{1}{\sqrt{2}} 〈 gg \vert {e}^{- i \frac{e}{ℏ} α d ( {\hat{a}}_{1}^{†} + {\hat{a}}_{1} - {\hat{a}}_{2}^{†} - {\hat{a}}_{2} )} ( \vert eg 〉 + \vert ge 〉 ) = \frac{1}{\sqrt{2}} 〈 gg \vert {e}^{- i \frac{e}{ℏ} α d ( {\hat{a}}_{1}^{†} + {\hat{a}}_{1} )} {e}^{i \frac{e}{ℏ} α d ( {\hat{a}}_{2}^{†} + {\hat{a}}_{2} )} ( \vert eg 〉 + \vert ge 〉 ) = \frac{1}{\sqrt{2}} 〈 gg \vert {e}^{- i \frac{e}{ℏ} α d {\hat{a}}_{1}^{†}} {e}^{- i \frac{e}{ℏ} α d {\hat{a}}_{1}} {e}^{i \frac{e}{ℏ} α d {\hat{a}}_{2}^{†}} {e}^{i \frac{e}{ℏ} α d {\hat{a}}_{2}} ( \vert eg 〉 + \vert ge 〉 = \frac{1}{\sqrt{2}} ( 〈 gg \vert {e}^{- i \frac{e}{ℏ} α d {\hat{a}}_{1}^{†}} {e}^{- i \frac{e}{ℏ} α d {\hat{a}}_{1}} \vert eg 〉 + 〈 gg \vert {e}^{i \frac{e}{ℏ} α d {\hat{a}}_{2}^{†}} {e}^{i \frac{e}{ℏ} α d {\hat{a}}_{2}} \vert ge 〉 ) = \frac{1}{\sqrt{2}} ( - i \frac{e}{ℏ} α d ) + \frac{1}{\sqrt{2}} i \frac{e}{ℏ} α d = 0. \qquad ( 25 )$$

A two-transmon circuit with suitable coupling locations may be therefore configured to suppress certain transmon state transition(s) via the difference of charge operation of the transmons. Capacitances of the coupling capacitor may be selected to be substantially equal.

### Resonators as the Quantum Mechanical System

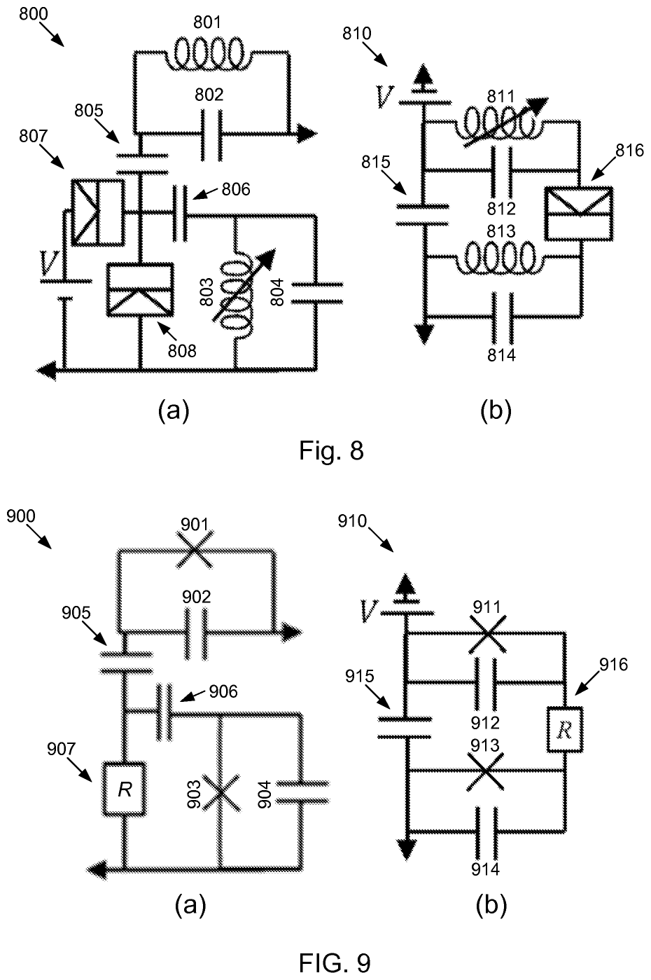

Quantum mechanical environment 211 may comprise a QCR and quantum mechanical system 212 may comprise a plurality of resonator circuits. Examples of quantum mechanical systems with two resonator circuits are illustrated in FIG. 8. When two resonators are coupled to quantum mechanical environment 211 through the sum or difference of their charge operators, it is possible to suppress certain state transitions, as will be described with reference to the two example circuits of FIG. 8.

FIG. 8a illustrates an example of an electric circuit 800 for implementing a sum of charge coupling of two or more resonator circuits (resonator) to a QCR through the sum of their charge operators. Structure of the diagram describing the circuit 800 may be similar to the diagram describing circuit 700, with the exception that the Josephson junctions have been replaced by inductors. Circuit 800 may comprise a first inductor 801 coupled in parallel with first capacitor 802. The combination of inductor 801 and capacitor 802 may be configured to operate as a first resonator circuit. Circuit 800 may comprise a second inductor 803 coupled in parallel with a second capacitor 804. The combination of inductor 803 and capacitor 804 may be configured to operate as a second resonator circuit. Resonance frequency of one or both of the resonator circuits may be tunable In this example, the second resonator circuit is tunable by changing inductance of inductor 803. Tuning may be configured to be implemented for example by a superconducting quantum interference device (SQUID). The resonators may be implemented for example as two coplanar waveguide resonators. The resonators may be preconfigured such that they have substantially same resonance frequency or one or both of the resonators may be tuned such that the resonators have substantially the same resonance frequency. It is however noted that tuning the first and second resonator frequencies to the same resonance frequency may not be needed in all applications. In general, it may be sufficient that the products of the capacitance and the angular frequency of each resonator coincide, i.e., C₁ω₁=C₂ω₂, where Cₘ and ωₘ are the capacitance and angular frequency of an m-th resonator circuit, respectively. This can be seen for example from the definition of d after Equation (27) below.

The first and second resonator circuits may be capacitively coupled via coupling capacitors 805, 806 to a QCR, comprising in this example two NIS tunnel junctions 807, 808 coupled in parallel to each other and to a common voltage source. The QCR may be biased with a DC voltage V from a voltage source of the circuit. Capacitances of coupling capacitors 805, 806 may be equal. The set of parameters characterizing the coupling of the resonator qubits to the QCR may therefore comprise substantially equal capacitances for coupling capacitors 805, 806. Coupling locations of the resonators to the QCR, e.g., connection points of the coupling capacitors 805, 806, may be selected such that the resonators are coupled to the QCR (e.g., the normal metal island of a single QRC) by their sum of charge operators.

FIG. 8b illustrates an example of an electric circuit 810 for implementing a difference of charge coupling of two resonators to a QCR through the difference of their charge operators. Circuit 810 may comprise a first inductor 811 coupled in parallel with first capacitor 812. The combination of inductor 811 and capacitor 812 may be configured to operate as a first resonator circuit. Circuit 810 may comprise a second inductor 813 coupled in parallel with a second capacitor 814. The combination of inductor 713 and capacitor 814 may be configured to operate as a second resonator circuit. The first and second resonator circuits may be capacitively coupled to each other by capacitor 815. The first and second resonator circuits may be coupled a QCR, comprising in this example a single NIS tunnel junction 816. Resonance frequency of one or both of the resonator circuits may be tunable. In this example, the first resonator circuit is tunable by tuning inductance of first inductor 811, similar to the second resonator circuit of FIG. 8a. DC voltage V may be supplied from a voltage source to the first resonator circuit and capacitor 815. Coupling locations of the resonators to the QCR, e.g. connection points of the resonator circuits may be selected such that the resonators are coupled to the QCR by the difference of their charge operators.

Next, capacitive coupling of two coplanar waveguide resonators, the resonance frequency of one of which is tunable is considered in more detail for the scenarios of coupling with the sum or difference of charge (cf. circuits 800 or 810). A single QCR may be coupled each resonator at a single point similar to FIG. 7a and FIG. 7b in case of two transmons.

If the resonators are tuned in resonance, the QCR coupling scheme determines whether it dissipates the common or the differential mode. The origin of this effect can be understood by defining the common and the differential mode as |Ψ^{c} [symbol] =(|10 [symbol] +|01 [symbol] )\sqrt{2} and |Ψ_{d} [symbol] =(|10 [symbol] −|01 [symbol] )\sqrt{2}, respectively, and calculating the matrix elements of the |00 [symbol] ↔|Ψ^{c} [symbol] transition and the |00 [symbol] ↔|Ψ^{d} [symbol] transition similar to the case of transmon circuits, for example as follows:

$${M}_{c , 00} = 〈 00 \vert {e}^{- i \frac{e}{ℏ} α {\hat{ϕ}}_{1}} \vert {Ψ}^{c} 〉 = \frac{1}{\sqrt{2}} 〈 00 \vert {e}^{- i \frac{e}{ℏ} α d ( {\hat{a}}_{1}^{†} + {\hat{a}}_{1} - {\hat{a}}_{2}^{†} - {\hat{a}}_{2} )} ( \vert 10 〉 + \vert 01 〉 ) = 0 , \qquad ( 26 )$$

$${M}_{d , 00} = 〈 00 \vert {e}^{- i \frac{e}{ℏ} α {\hat{ϕ}}_{1}} \vert {Ψ}^{d} 〉 = \frac{1}{\sqrt{2}} 〈 00 \vert {e}^{- i \frac{e}{ℏ} α d ( {\hat{a}}_{1}^{†} + {\hat{a}}_{1} + {\hat{a}}_{2}^{†} + {\hat{a}}_{2} )} ( \vert 10 〉 - \vert 01 〉 ) = 0 , \qquad ( 27 )$$

where d=\sqrt{ℏ/(2C₁ω₁)}=\sqrt{ℏ/(2C₂ω₂)}, and Cⱼ and ωⱼ are the capacitance and the angular frequency of the j-th resonator, respectively. A two-resonator circuit with suitable coupling locations may be therefore configured to suppress certain transmon state transition(s) via the sum of charge or difference of charge operators of the resonators.

It is noted that similar effect of sum of charge or difference of charge may be obtained by other circuit arrangements or topologies. Circuits 700, 710, 800, 810 are provided as examples of such circuits with suitable coupling locations. In the examples of FIG. 7 and FIG. 8, determining the coupling locations may not include determination of particular distances from components of the transmon qubit circuits or resonator circuits, or a distance between the coupling locations, but rather determining locations that are at a suitable potential level and coupled to the QCR in a suitable order, in order to cause coupling through the sum of charge or difference of charge of the transmon qubit or resonator circuits. Furthermore, the scenarios of two transmons or two resonators may be generalized to more than two transmons or resonators, respectively.

### Ohmic as the Quantum Mechanical Environment

Quantum mechanical environment 211 may comprise an Ohmic resistor, which is provided as another example of a dissipative element. An Ohmic resistor may be a resistor with Ohmic spectral density.

### Multi-Mode Unimon as the Quantum Mechanical System

Quantum mechanical environment 211 may comprise an Ohmic resistor and quantum mechanical system 212 may comprise a multi-mode unimon. The multi-mode unimon may be coupled to the Ohmic resistor at a single coupling location configured to cause intentional suppression of certain state transition(s).

Considering an example scenario of a two-mode unimon coupled to an Ohmic resistor at a single coupling point, the interaction Hamiltonian between the two-mode unimon and the resistor reads

$${\hat{H}}_{I} / ℏ = {\sum }_{m = 1}^{2} {\sum }_{k} [ {J}_{m} ( {ω}_{k} ) {\hat{a}}_{m} {\hat{A}}_{k}^{†} + H . c . ] , \qquad ( 28 )$$

where H.c. denotes the Hermitian conjugate, and

$${J}_{m} ( {ω}_{k} ) = {J}_{m} \sqrt{{ω}_{k}} . \qquad ( 29 )$$

Consequently, the transition matrix elements of the |e [symbol] ↔|g [symbol] and |f [symbol] ↔|g [symbol] transitions read

$${\sum }_{l} 〈 {1}_{l} \vert 〈 g \vert {\hat{H}}_{I} \vert e 〉 \vert {0}_{l} = {\sum }_{l} 〈 {1}_{l} \vert 〈 00 \vert {\sum }_{m = 1}^{2} {\sum }_{k} [ {J}_{m} ( {ω}_{k} ) {\hat{a}}_{m} {\hat{A}}_{k}^{†} + H . c . ] ( {c}_{e , 10} \vert 10 〉 + {c}_{e , 01} \vert 01 〉 ) \vert {0}_{l} 〉 = {c}_{e , 10} {\sum }_{l} 〈 {1}_{l , σ} \vert {\sum }_{k} {J}_{1} ( {ω}_{k} ) {\hat{A}}_{k}^{†} \vert {0}_{l} 〉 + {c}_{e , 01} {\sum }_{l} 〈 {1}_{l} \vert {\sum }_{k} {J}_{2} ( {ω}_{k} ) {\hat{A}}_{k}^{†} \vert {0}_{l} 〉 = {c}_{e , 10} {\sum }_{k} {J}_{1} ( {ω}_{k} ) + {c}_{e , 01} {\sum }_{k} {J}_{2} ( {ω}_{k} ) = {c}_{e , 10} {J}_{1} {\sum }_{k} \sqrt{{ω}_{k}} + {c}_{e , 01} {J}_{2} {\sum }_{k} \sqrt{{ω}_{k}} , \qquad ( 30 )$$

$${\sum }_{l} 〈 {1}_{l} \vert 〈 g \vert {\hat{H}}_{I} \vert f 〉 \vert {0}_{l} 〉 = {c}_{f , 10} {J}_{1} {\sum }_{k} \sqrt{{ω}_{k}} + {c}_{f , 01} {J}_{2} {\sum }_{k} \sqrt{{ω}_{k}} , \qquad ( 31 )$$

where |0ₗ [symbol] denotes the vacuum state of quantum mechanical environment 211, and

$$\vert {1}_{l} 〉 = {\hat{A}}_{l}^{†} \vert {0}_{l} 〉 ,$$

and

$${\hat{A}}_{l}^{†}$$

is the creation operator of the l-th mode of quantum mechanical environment 211. It is possible to cancel the |e [symbol] ↔|g [symbol] transition by tuning the physical parameters of quantum mechanical system 212 and the coupling (e.g., coupling strengths Jₘ) to satisfy

$${c}_{e , 10} {J}_{1} + {c}_{e , 01} {J}_{2} = 0. \qquad ( 32 )$$

Coupling strength to the two unimon may be for example adjusted based on the distance of the respective single superconductive pattern (cf., 403 or 404) from coplanar waveguide 401. Assuming that the coupling strengths to the modes is constant up to the prefactor of the mode envelope function, uₘ(x_{g}), i.e., are Ju₁(x_{g}) and Ju₂(x_{g}) the condition can be written as

$${c}_{e , 10} {u}_{1} ( {x}_{g} ) + {c}_{e , 01} {u}_{2} ( {x}_{g} ) = 0 ⇒ \frac{{u}_{1} ( {x}_{g} )}{{u}_{2} ( {x}_{g} )} = - \frac{{c}_{e , 01}}{{c}_{e , 10}} = \frac{ζ}{\sqrt{{Δ}^{2} + {ζ}^{2}} - Δ} . \qquad ( 33 )$$

Hence, the |e [symbol] ↔|g [symbol] transition may be cancelled of the ratio of envelope functions

$$\frac{{u}_{1} ( {x}_{g} )}{{u}_{2} ( {x}_{g} )}$$

(at the single coupling location x_{g}) satisfies the condition

$$- \frac{{c}_{e , 01}}{{c}_{e , 10}} .$$

The single coupling location may be selected such that certain transition(s) are intentionally suppressed. In this example the single coupling location may be selected such that condition (33) is satisfied. The single coupling location x_{g} may be determined based on the ratio of envelope functions of the two modes at the single coupling location. Considering the result of (33) in view of Equations (12), (13), and (14), the ratio of the envelope functions at the single coupling location may be configured to satisfy a condition that is based on the frequencies of the modes of the multi-mode unimon (ωₘ) and other parameter(s) of the multi-mode unimon, such as for example capacitance(s) associated with the coupling. Examples of formulating the condition are provided in Equation (33). The single coupling location may be selected such that this condition is satisfied, for example by solving Equation (33) for x_{g}. The set of parameters affecting selection of the single coupling location for suppressing the state transition(s) may therefore comprise modes of the multi-mode unimon and other parameter(s) of the multi-mode unimon, e.g., the capacitances between the multi-mode unimon and quantum mechanical environment 211 (e.g., Ohmic resistor as in this example). Note that the |f [symbol] ↔|g [symbol] transition is left uncancelled (except for the non-interesting case of ζ=0 corresponding to the modes being linear.) This feature may be utilized, e.g., to suppress the leakage error during quantum information processing.

### Transmons as the Quantum Mechanical System

Quantum mechanical environment 211 may comprise an Ohmic resistor and quantum mechanical system 212 may comprise a plurality of transmons.

FIG. 9a illustrates an example of an electric circuit 900 for implementing sum of charge coupling of two transmons to an Ohmic resistor 907. Circuit 900 may comprise a first Josephson's junction 901 coupled in parallel with first capacitor 902. The combination of Josephson junction 901 and capacitor 902 may be configured to operate as a first transmon qubit circuit. Circuit 900 may comprise a second Josephson junction 903 coupled in parallel with a second capacitor 904. The combination of Josephson junction 903 and capacitor 904 may be configured to operate as a second transmon qubit circuit. The first and second transmon qubit circuits may be capacitively coupled via coupling capacitors 905, 906 to Ohmic resistor 907. The first and second transmon qubit circuits may be identical. Capacitances of coupling capacitors 905, 906 may be equal. The set of parameters characterizing the coupling of the transmon qubits to Ohmic resistor 907 may therefore comprise substantially equal capacitances for coupling capacitors 905, 906. Coupling locations (e.g., connection points of capacitors 905, 906) of the transmons to Ohmic resistor 907 may be selected such that the transmons are coupled to Ohmic resistor 907 by their sum of charge operator. Circuit 900 provides an example of such coupling locations. This enables certain state transition(s) to be suppressed, as will be shown below.

It is generally noted that the circuits described herein may comprise further components or be connected to further circuits, as illustrated by the indicative of potential connection points to arrows other parts of the circuit or other circuits.

The effect of filtering of the noise spectrum of a quantum mechanical system comprising transmon qubits may be obtained by utilizing a resistor with Ohmic spectral density as the dissipative element. Similar to the example of a multi-mode unimon coupled to an Ohmic resistor as quantum mechanical environment 211, the interaction Hamiltonian of the system reads

$${\hat{H}}_{I} / ℏ = {\sum }_{m = 1}^{2} {\sum }_{k} [ {J}_{m} ( {ω}_{k} ) {\hat{a}}_{m} {\hat{A}}_{k}^{†} + H . c . ] , \qquad ( 34 )$$

where, for example in case of equal coupling capacitance 905, 906 between each transmon qubit and Ohmic resistor 907, the interaction strength is qubit-independent:

$${J}_{m} ( {ω}_{k} ) = J \sqrt{{ω}_{k}} . \qquad ( 35 )$$

The transition matrix element of the |Ψ⁻ [symbol] ↔|Ψ^{g} [symbol] transition induced by this coupling vanishes, since

$$\begin{matrix}{M}_{- , g} = {\sum }_{l} 〈 {1}_{l} \vert 〈 {Ψ}^{g} \vert {\hat{H}}_{I} \vert {Ψ}^{-} 〉 \vert {0}_{l} 〉 \\ = \frac{J}{\sqrt{2}} {\sum }_{l} {\sum }_{k} \sqrt{{ω}_{k}} 〈 {1}_{l} \vert 〈 g g \vert ( {\hat{a}}_{1} {\hat{A}}_{k}^{†} + {\hat{a}}_{2} {\hat{A}}_{k}^{†} + \\ {\hat{a}}_{1}^{†} {\hat{A}}_{k} + {\hat{a}}_{2}^{†} {\hat{A}}_{k} ) ( \vert e g 〉 - \vert g e 〉 ) \vert {0}_{l} 〉 \\ = \frac{J}{\sqrt{2}} {\sum }_{l} {\sum }_{k} \sqrt{{ω}_{k}} 〈 {1}_{l} \vert 〈 g g \vert ( {\hat{a}}_{1} + {\hat{a}}_{2} ) ( \vert e g 〉 - \vert ge 〉 ) \vert {1}_{k} 〉 \\ = \frac{J}{\sqrt{2}} {\sum }_{k} \sqrt{{ω}_{k}} 〈 g g \vert ( {\hat{a}}_{1} + {\hat{a}}_{2} ) ( \vert e g 〉 - \vert ge 〉 ) \\ = \frac{J}{\sqrt{2}} {\sum }_{k} \sqrt{{ω}_{k}} ( 1 - 1 ) \\ = 0.\end{matrix} \qquad ( 36 )$$

It is therefore possible to suppress desired state transition(s) by selecting coupling locations such that the coupling is through a sum of charge operator of the transmon qubits coupled to an Ohmic resistor.

FIG. 9b illustrates an example of an electric circuit 910 for implementing difference of charge coupling of two transmons to an Ohmic resistor 916. Circuit 910 may comprise a first Josephson junction 911 coupled in parallel with first capacitor 912. The combination of Josephson junction 911 and capacitor 912 may be configured to operate as a first transmon qubit circuit. Circuit 910 may comprise a second Josephson junction 913 coupled in parallel with a second capacitor 914. The combination of second Josephson junction 913 and capacitor 914 may be configured to operate as a second transmon qubit circuit. The first and second transmon qubits may be capacitively coupled to each other by capacitor 915. The first and second transmon qubits may be coupled to an Ohmic resistor 916. DC voltage V may be supplied from a voltage source to the first transmon qubit circuit and capacitor 915. Coupling locations of the transmon qubits to Ohmic resistor 916, e.g. connection points of the transmon qubit circuits may be selected such that the transmon qubits are coupled to Ohmic resistor 916 by the difference of their charge operators.

In the case of the example configuration of FIG. 9b, the transition matrix element of the |Ψ⁺ [symbol] ↔|Ψ^{g} [symbol] transition induced by this coupling vanishes, since

$$\begin{matrix}{M}_{+ , g} = {\sum }_{l} 〈 {1}_{l} \vert 〈 {Ψ}^{g} \vert {\hat{H}}_{I} \vert {Ψ}^{+} 〉 \vert {0}_{l} 〉 \\ = \frac{J}{\sqrt{2}} {\sum }_{l} {\sum }_{k} \sqrt{{ω}_{k}} 〈 {1}_{l} \vert 〈 g g \vert ( {\hat{a}}_{1} {\hat{A}}_{k}^{†} - {\hat{a}}_{2} {\hat{A}}_{k}^{†} + \\ = {\hat{a}}_{1}^{†} {\hat{A}}_{k} - {\hat{a}}_{2}^{†} {\hat{A}}_{k} ) ( \vert e g 〉 + \vert g e 〉 ) \vert {0}_{l} 〉 \\ = \frac{J}{\sqrt{2}} {\sum }_{l} {\sum }_{k} \sqrt{{ω}_{k}} 〈 {1}_{l} \vert 〈 g g \vert ( {\hat{a}}_{1} - {\hat{a}}_{2} ) ( \vert e g 〉 + \vert ge 〉 ) \vert {1}_{k} 〉 \\ = \frac{J}{\sqrt{2}} {\sum }_{k} \sqrt{{ω}_{k}} 〈 g g \vert ( {\hat{a}}_{1} - {\hat{a}}_{2} ) ( \vert e g 〉 + \vert ge 〉 ) \\ = \frac{J}{\sqrt{2}} {\sum }_{k} \sqrt{{ω}_{k}} ( 1 - 1 ) \\ = 0.\end{matrix} \qquad ( 36 b )$$

It is therefore possible to suppress desired state transition(s) by selecting coupling locations such that the coupling is through a difference of charge operator of the transmon qubits coupled to an Ohmic resistor.

### Transmission Line as the Quantum Mechanical Environment

A transmission line may comprise a one-dimensional waveguide configured to enable coupling to quantum mechanical system 212, for example for providing a channel for signal delivery or to dissipatively removing energy from quantum mechanical system 212. A transmission line, illustrated in FIG. 10 with the dotted line, may be characterized by its length and its capacitance (C). The transmission line may be connected to a voltage source at one end, for example via a first resistor 1001. The transmission line may be connected to ground at the other end, for example via a second resistor 1002. The first and second resistors 1001, 1002 may have substantially equal resistance, for example 50 Ohm. Length of the transmission line between the two points at which it is coupled to QCR 1003 defines the half wavelength (λ/2) of a mode of the transmission line. Energy of such a mode may be intentionally absorbed by the QCR by selecting the length λ/2 to match the half wavelength of the mode energy of which is to be absorbed. The transmission line may carry modes with continuous spectrum while a superconducting qubit may carry a discrete spectrum of modes. The length may not be relevant when using a unimon as quantum mechanical system 212.

Quantum mechanical system 212 may be coupled to the transmission line at one or more coupling locations. Again, by proper selection of the coupling location(s), considering also other parameters characterising the coupling, certain state transition(s) may be intentionally suppressed. Even though FIG. 9 illustrates a QCR, represented in this example by a single NIS junction 1003, coupled to the transmission line, it is also possible to couple other type of quantum mechanical systems (e.g., a multi-mode unimon) to the transmission line. A multi-mode unimon may be coupled to the transmission line at one or more (e.g., two) coupling locations.

### Multi-Mode Unimon as the Quantum Mechanical System

Quantum mechanical environment 211 may comprise a transmission line and quantum mechanical system 212 may comprise a multi-mode unimon. Desired state transition(s) may be suppressed by selecting a single coupling location such that transition matrix elements associated with these state transition(s) vanish or at least get reduced.

Considering an example of a two-mode unimon coupled to a transmission line at a single coupling location x_{g}, and using the rotating-wave approximation, the interaction Hamiltonian between the two-mode unimon system and the transmission line reads

$$\frac{{\hat{H}}_{I}}{h} = {\sum }_{m = 1}^{2} {\sum }_{k} [ {J}_{m} ( {ω}_{k} ) {\hat{a}}_{m} {\hat{A}}_{k , L}^{†} + {J}_{m}^{*} ( {ω}_{k} ) {\hat{a}}_{m} {\hat{A}}_{k , R}^{†} + H . c . ] \qquad ( 37 )$$

$$where$$

$${J}_{m} ( {ω}_{k} ) = {J}_{m} {ω}_{k} {e}^{- i {ω}_{k} {x}_{g} / v} , \qquad ( 38 )$$

$${J}_{m} = J {u}_{m} ( {x}_{g} ) , \qquad ( 39 )$$

and v is the speed of light in the waveguide (transmission line). Consequently, the transition matrix element of the |g [symbol] ↔|e [symbol] transition is

$$\begin{matrix}{\sum }_{l , σ} ( {1}_{l , σ} \vert ( g \vert {\hat{H}}_{I} \vert e 〉 \vert {0}_{l , σ} 〉 = {\sum }_{l , σ} 〈 {1}_{l , σ} \vert 〈 00 \vert {\sum }_{m = 1}^{2} {\sum }_{k} [ {J}_{m} ( {ω}_{k} ) {\hat{a}}_{m} {\hat{A}}_{k , L}^{†} + \\ {J}_{m}^{*} ( {ω}_{k} ) {\hat{a}}_{m} {\hat{A}}_{k , R}^{†} + H . c . ] ( {c}_{e , 10} \vert 10 〉 + \\ {c}_{e , 01} \vert 01 〉 ) \vert {0}_{l , σ} 〉 \\ = {c}_{e , 10} {\sum }_{l , σ} 〈 {1}_{l , σ} \vert {\sum }_{k} [ {J}_{1} ( {ω}_{k} ) {\hat{A}}_{k , L}^{†} + \\ {J}_{1}^{*} ( {ω}_{k} ) {\hat{A}}_{k , R}^{†} ] \vert {0}_{l , σ} 〉 + \\ {c}_{e , 01} {\sum }_{l , σ} 〈 {1}_{l , σ} \vert {\sum }_{k} [ {J}_{2} ( {ω}_{k} ) {\hat{A}}_{k , L}^{†} + \\ {J}_{2}^{*} ( {ω}_{k} ) {\hat{A}}_{k , R}^{†} ] \vert {0}_{l , σ} 〉 \\ = {c}_{e , 10} {\sum }_{k} [ {J}_{1} ( {ω}_{k} ) + {J}_{1}^{*} ( {ω}_{k} ) ] + \\ {c}_{e , 01} {\sum }_{k} [ {J}_{2} ( {ω}_{k} ) + {J}_{2}^{*} ( {ω}_{k} ) ] \\ = {Jc}_{e , 10} {u}_{1} ( {x}_{g} ) {\sum }_{k} {ω}_{k} \\ ( {e}^{- \frac{i {ω}_{k} {x}_{g}}{v}} + {e}^{+ \frac{i {ω}_{k} {x}_{g}}{v}} ) + \\ {Jc}_{e , 01} {u}_{2} ( {x}_{g} ) {\sum }_{k} {ω}_{k} ( {e}^{- i {ω}_{k} {x}_{g} / v} + {e}^{+ i {ω}_{k} {x}_{g} / v} ) \\ = J {\sum }_{k} {ω}_{k} ( {e}^{- i {ω}_{k} {x}_{g} / v} + {e}^{+ i {ω}_{k} {x}_{g} / v} ) \\ [ {c}_{e , 10} {u}_{1} ( {x}_{g} ) + {c}_{e , 01} {u}_{2} ( {x}_{g} ) ] .\end{matrix} \qquad ( 40 )$$

The matrix element vanishes if

$${c}_{e , 10} {u}_{1} ( {x}_{g} ) + {c}_{e , 01} {u}_{2} ( {x}_{g} ) = 0 \qquad ( 41 )$$

$$⇒ \frac{{u}_{1} ( {x}_{g} )}{{u}_{2} ( {x}_{g} )} = - \frac{{c}_{e , 01}}{{c}_{e , 10}}$$

$$= \frac{ζ}{\sqrt{{Δ}^{2} + {ζ}^{2}} - Δ}$$

The single coupling location may be selected such that certain transition(s) are intentionally suppressed. In this example the single coupling location may be determined such that condition (41) is satisfied. The single coupling location x_{g} may be determined based on the ratio of envelope functions of the two modes at the single coupling location, for example by solving x_{g} from Equation (41). Similar to the example of Ohmic resistor 907 as quantum mechanical environment 211, the ratio of the envelope functions of the modes at the single coupling location may be determined based on the frequencies of the modes of the multi-mode unimon (ωₘ) and other parameter(s) of the multi-mode unimon, such as for example capacitance(s) associated with the coupling (cf. Equations 12 to 14).

Therefore, also in case of a transmission line as quantum mechanical environment 211, the set of parameters affecting the selection of the single coupling location for intentionally suppressing certain transition(s) may comprise modes of the multi-mode unimon and capacitances between the multimode unimon and quantum mechanical environment 211 (e.g., transmission line as in this example). Since we have decoupled the |g [symbol] ↔|e [symbol] -transition from the transmission line but left the |e [symbol] ↔|f [symbol] and |e [symbol] ↔|h [symbol] transitions coupled, it is possible to measure the state of the two-mode unimon qubit by, e.g., driving one of those transitions, letting the state to relax to a lower excited state, and detecting the photons absorbed to the transmission line.

### Unimon and its Intrinsic Mode for Readout as the Quantum Mechanical System

Quantum mechanical environment 211 may comprise a transmission line and quantum mechanical system 212 may comprise a unimon. As describe above, a unimon may comprise a half-wavelength coplanar waveguide (CPW) resonator, which may be grounded at both ends. A Josephson junction may be provided in the centre superconductor of the resonator. The nonlinearity of the Josephson junction makes one of the normal modes of the CPW resonator anharmonic. A unimon may use one of the normal modes of its coplanar waveguide structure as the qubit. Another one of the normal modes may be used as a readout resonator mode. The state of the qubit mode alters the resonance frequency of the readout resonator mode, which enables to perform a measurement of the qubit state. An external read-out resonator is therefore not needed. When such unimon is coupled to a transmission line at two coupling locations, it is again possible to select the coupling locations such that certain state transition(s) of the qubit mode are intentionally suppressed.

In this example, coupling of a two-mode unimon at two points x_{g,1} and x_{g,2} to a transmission line is considered. Instead of using the two least energetic eigenstates of the system as a qubit, one of the modes is used as the qubit mode and the other mode is used as the readout mode. Coupling the two-mode unimon to the transmission line can be described by the interaction Hamiltonian

$${\hat{H}}_{I} / ℏ = {\sum }_{m = 1}^{2} {\sum }_{k} [ {J}_{m} ( {ω}_{k} ) {\hat{a}}_{m} {\hat{A}}_{k , L}^{†} + {J}_{m}^{*} ( {ω}_{k} ) {\hat{a}}_{m} {\hat{A}}_{k , R}^{†} + H . c . ] , \qquad ( 42 )$$

$$where$$

$${J}_{m} ( {ω}_{k} ) = {J}_{m} {ω}_{k} {\sum }_{n = 1}^{2} {e}^{- i {ω}_{k} {x}_{g , n} / v} , \qquad ( 43 )$$

$${J}_{m} = J {u}_{m} ( {x}_{g} ) . \qquad ( 44 )$$

Consequently, the transition matrix element of the |00 [symbol] ↔|10 [symbol] transition reads

$$\begin{matrix}{\sum }_{l , σ} ( {1}_{l , σ} \vert ( 00 \vert {\hat{H}}_{I} \vert 10 〉 \vert {0}_{l , σ} 〉 = {\sum }_{l , σ} 〈 {1}_{l , σ} \vert 〈 00 \vert {\sum }_{m = 1}^{2} \\ {\sum }_{k} [ {J}_{m} ( {ω}_{k} ) {\hat{a}}_{m} {\hat{A}}_{k , L}^{†} + \\ {J}_{m}^{*} ( {ω}_{k} ) {\hat{a}}_{m} {\hat{A}}_{k , R}^{†} + H . c . ] \vert 10 〉 \vert {0}_{l , σ} 〉 \\ = {\sum }_{l , σ} 〈 {1}_{l , σ} \vert {\sum }_{k} [ {J}_{1} ( {ω}_{k} ) {\hat{A}}_{k , L}^{†} + \\ {J}_{1}^{*} ( {ω}_{k} ) {\hat{A}}_{k , R}^{†} ] \vert {0}_{l , σ} 〉 \\ = {\sum }_{k} [ {J}_{1} ( {ω}_{k} ) + {J}_{1}^{*} ( {ω}_{k} ) ] \\ = {Ju}_{1} ( {x}_{g , 1} ) {\sum }_{k} {ω}_{k} ( {e}^{- i {ω}_{k} {x}_{g , 1} / v} + \\ {e}^{+ i {ω}_{k} {x}_{g , 1} / v} ) + \\ {Ju}_{1} ( {x}_{g , 2} ) {\sum }_{k} {ω}_{k} ( {e}^{- i {ω}_{k} {x}_{g , 2} / v} + \\ {e}^{+ i {ω}_{k} {x}_{g , 2} / v} ) .\end{matrix} \qquad ( 45 )$$

Consequently, the condition for cancelling the transition reads

$$\frac{{u}_{1} ( {x}_{g , 1} )}{{u}_{1} ( {x}_{g , 2} )} = - \frac{{\sum }_{k} {ω}_{k} ( {e}^{- i {ω}_{k} {x}_{g , 2} / v} + {e}^{+ i {ω}_{k} {x}_{g , 2} / v} )}{{\sum }_{k} {ω}_{k} ( {e}^{- i {ω}_{k} {x}_{g , 1} / v} + {e}^{+ i {ω}_{k} {x}_{g , 1} / v} )} . \qquad ( 46 )$$

The coupling locations x_{g,1}, x_{g,2} may be therefore determined based on the ratio of envelope functions of the qubit mode at the two coupling locations. For example, the ratio of the envelope functions may be configured to be equal to

$$- \frac{{\sum }_{k} {ω}_{k} ( {e}^{- i {ω}_{k} {x}_{g , 2} / v} + {e}^{+ i {ω}_{k} {x}_{g , 2} / v} )}{{\sum }_{k} {ω}_{k} ( {e}^{- i {ω}_{k} {x}_{g , 1} / v} + {e}^{+ i {ω}_{k} {x}_{g , 1} / v} )} .$$

In general, the two coupling locations may be determined based on a ratio of envelope functions of the qubit mode at the two coupling locations and frequencies (dk) of the modes (e.g., two modes). The ratio of envelope functions may be configured to satisfy a condition (cf. Eq. (46)), where the condition is defined based on the modes (ωₖ) of the unimon. Thus, it is possible to read out the state of the qubit mode using the intrinsic readout mode while avoiding the qubit mode to decay to the transmission line. It is noted more than one pair of coupling locations may satisfy condition (46). The sums at the nominator and denominator of Equation (46) may comprise a combined (e.g., total) coupling strength between the unimon and the transmission line at the respective coupling locations. The condition for the ratio of envelope functions at the coupling location may therefore comprise the ratio of the combined coupling strengths between the unimon and the transmission line at the coupling locations. The ratio may be negated to obtain the condition.

Multiunimon is another type of a unimon that may be used as, or within, quantum mechanical system 212 with any suitable quantum mechanical environment 211, such as for example a QRC, an Ohmic resistor, or a transmission line. A multiunimon may have similar physical appearance as other unimon(s), but configured with different parameters. A multiunimon may be configured to operate such that multiple normal modes are configured to act as qubits. The coupling between the respective modes may be configured to couple the qubits.

It is noted that whenever a unimon, for example a multi-mode unimon, a unimon configured with its intrinsic mode as the read-out mode, or a multiunimon, is embodied as quantum mechanical system 212, the system may comprise a plurality of such unimons. The unimons may be coupled to each other and configured to operate as a multi-qubit quantum processor that enables entanglement between qubits. For example, quantum mechanical system may comprise a plurality of multi-mode unimons or a plurality of multiunimons.

### OCR as the Quantum Mechanical System

Quantum mechanical environment 211 may comprise a transmission line and quantum mechanical system 212 may comprise a QCR. In the example of FIG. 10, a transmission line is coupled to a QCR, comprising in this example a single NIS tunnel junction 1003, at two coupling locations x_{g,1} and x_{g,2}. The system can be used as a reflectionless band-pass microwave filter for the signal in the transmission line. To understand the origin of this effect, we calculate the transition matrix elements of the transmission line caused by the interaction with the QCR as

$$\begin{matrix}{M}_{01 , k , L} = 〈 {0}_{k , L} \vert {e}^{- ia ( {\hat{ϕ}}_{1} + {\hat{ϕ}}_{2} )} \vert {1}_{k , L} 〉 \\ = 〈 {0}_{k , L} \vert {e}^{- {iad}_{k} [ {\hat{A}}_{k , L}^{†} ( {e}^{- i {ω}_{k} {x}_{g , 1} / v} + {e}^{- t {ω}_{k} {x}_{g , 2} / v} ) + {\hat{A}}_{k , L} ( {e}^{i {ω}_{{k}^{x} g , 1} / v} + {e}^{i {ω}_{k} {x}_{g , 2} / v} ) ]} \vert {1}_{k , L} 〉 \\ = {e}^{{- {a}^{2} {d}_{k}^{2} \vert {e}^{i {ω}_{k} {x}_{g , 1} / v} + {e}^{i {ω}_{k} {x}_{g , 2} / v} \vert}^{2}} / 2 \times \\ 〈 {0}_{k , L} \vert {e}^{- {iad}_{k} {\hat{A}}_{k , L}^{†} ( {e}^{- i {ω}_{k} {x}_{g , 1} / v} + {e}^{- i {ω}_{k} {x}_{g , 2} / v} )} {e}^{- {iad}_{k} {\hat{A}}_{k , L} ( {e}^{- i {ω}_{k} {x}_{g , 1} / v} + {e}^{- i {ω}_{k} {x}_{g , 2} / v} )} \vert {1}_{k , L} 〉 \\ = {e}^{{- {a}^{2} {d}_{k}^{2} \vert {e}^{i {ω}_{k} ( {x}_{g , 1} - {x}_{g , 2} ) / ( 2 v )} + {e}^{i {ω}_{k} ( {x}_{g , 2} - {x}_{g , 1} ) / ( 2 v )} \vert}^{2}} / 2 [ - ia {d}_{k} ( {e}^{i {ω}_{k} {x}_{g , 1} / v} + {e}^{i {ω}_{k} {x}_{g , 2} / v} ) ] \\ = - 2 ia {d}_{k} {e}^{- 2 {a}^{2} {d}_{k}^{2} {cos}^{2} [ \frac{{ω}_{k} ( {x}_{g , 2} - {x}_{g , 1} )}{2 v} ] - \frac{\dot{ι} {ω}_{k} ( {x}_{g , 1} + {x}_{g , 2} )}{2 v}} cos [ \frac{{ω}_{k} Δ {x}_{g}}{2 v} ] ,\end{matrix} \qquad ( 47 )$$

$$\begin{matrix}{M}_{01 , k , R} = 〈 {0}_{k , R} \vert {e}^{- ia ( {\hat{ϕ}}_{1} + {\hat{ϕ}}_{2} )} \vert {1}_{k , R} 〉 \\ = 〈 {0}_{k , R} \vert {e}^{- {iad}_{k} [ {\hat{A}}_{k , R}^{†} ( {e}^{i {ω}_{k} {x}_{g , 1} / v} + {e}^{i {ω}_{k} {x}_{g , 2} / v} ) + {\hat{A}}_{kR} ( {e}^{- i {ω}_{k} {x}_{g , 1} / v} + {e}^{- i {ω}_{k} {x}_{g , 2} / v} ) ]} \vert {1}_{k , R} 〉 \\ = - 2 ia {d}_{k} {e}^{- 2 {α}^{2} {d}_{k}^{2} {cos}^{2} [ \frac{{ω}_{k} ( {x}_{g , 2} - {x}_{g , 1} )}{2 v} ] + \frac{\dot{ι} {ω}_{k} ( {x}_{g , 1} + {x}_{g , 2} )}{2 v}} cos [ \frac{{ω}_{k} Δ {x}_{g}}{2 v} ] ,\end{matrix} \qquad ( 48 )$$

where Δx_{g}: =x_{g,2}−x_{g,1}. Hence, the matrix elements vanish if

$$cos [ {ω}_{k} Δ {x}_{g} / ( 2 v ) ] = 0 \qquad ( 49 )$$

$$⇒ \frac{{ω}_{k} Δ {x}_{g}}{2 v} = π / 2 + n π$$

$$⇒ \frac{Δ {x}_{g}}{{λ}_{k}} = 1 / 2 + n$$

$$⇒ Δ {x}_{g} = \frac{{λ}_{k}}{2} ( 1 + 2 n ) ,$$

where n∈ [symbol] , i.e., if the distance between the two points is an odd multiple of the half-wavelength of the mode that is configured to be intentionally not filtered.

Since the transmission line comprises a continuum of modes, there always exists some mode, the odd multiple of half-wavelength of which is equal to this distance. Selecting the distance based on the frequency of the desired mode enables avoiding filtering out the desired mode. This demonstrates that modes of the transmission line satisfying this criterion are not scattered due to quantum mechanical system 212 (e.g., QCR as in this example). Suppression of the desired transition(s) may be achieved by selecting the coupling locations based on this criterion.

Alternatively, the above example embodiment of quantum mechanical environment 211 comprising a transmission line and quantum mechanical system 212 comprise a QCR may be viewed the other way around, that is, quantum mechanical environment 211 comprising a QCR and quantum mechanical system 212 comprising a transmission line. The latter point of view may be taken for example because the QCR is the element configured to dissipate energy from the transmission line. The analysis of equations (47) to (49) holds either way.

FIG. 11 illustrates an example of a method for coupling a quantum mechanical system to a quantum mechanical environment. The method may be applied to a quantum mechanical system that is capable of exhibiting transitions between a plurality of eigenstates and capable of exhibiting modes from a continuous spectrum.

At 1101, the method may comprise providing at least one coupling location for coupling the quantum mechanical system to the quantum mechanical environment, wherein the quantum mechanical environment is capable of exhibiting modes from a continuous spectrum, and wherein said coupling is characterized with a set of parameters of the quantum mechanical system.

At 1102, the method may comprise coupling the quantum mechanical system to the quantum mechanical environment through the at least one coupling location, wherein a selected combination of the at least one coupling location and the set of parameters intentionally causes to suppress at least one of said transitions when intentionally changing a state of the quantum mechanical system by the quantum mechanical environment.

Various examples of the methods are explained above with regard to coupling of the various examples of quantum mechanical system 212 to the various examples of quantum mechanical environment 211, and are therefore not repeated here. It should be understood that example embodiments described may be combined in different ways unless explicitly disallowed.

Example embodiments therefore provide methods and arrangements for intentionally suppressing quantum mechanical state transition(s), when coupling a quantum mechanical system to quantum mechanical environment. This enables the noise spectrum of the quantum mechanical system to be filtered, thereby enabling more accurate coupling when delivering information between the system and the environment, for example for qubit driving or readout purposes. Example embodiments may be used with systems configured with or capable of exhibiting a continuous range of modes.

It is obvious to a person skilled in the art that with the advancement of technology, the example embodiments may be implemented in various ways and the scope of the present disclosure is therefore not limited to the examples described above, instead they may vary within the scope of the claims.

1. A quantum information processing system, comprising:
a quantum mechanical system capable of exhibiting transitions between a plurality of eigenstates, wherein the quantum mechanical system comprises a unimon qubit circuit comprising a coplanar waveguide, wherein the coplanar waveguide is intercepted by at least one Josephson junction and has a length between its two ends, wherein the unimon qubit circuit is configured with a plurality of modes; and
a quantum mechanical environment, wherein the quantum mechanical environment is capable of exhibiting modes from a continuous spectrum and is coupled to the quantum mechanical system at at least one coupling location, wherein said coupling is characterized with a set of parameters of the quantum mechanical system, and wherein a selected combination of the at least one coupling location and the set of parameters intentionally causes to suppress at least one of said transitions when intentionally changing a state of the quantum mechanical system by the quantum mechanical environment.

2. The quantum information processing system of claim 1, wherein said intentionally changing the state of the quantum mechanical system by the quantum mechanical environment comprises delivering information between the quantum mechanical system and the quantum mechanical environment or controlling the quantum mechanical system by the quantum mechanical environment.

3. The quantum information processing system according to claim 1, wherein the set of parameters characterizing the coupling comprises at least one parameter of the quantum mechanical environment.

4. The quantum information processing system according to claim 1, wherein the selected combination of the at least one coupling location and the set of parameters is configured to reduce or minimize an absolute value of at least one transition matrix element Mₖₗ of a transition matrix between eigenstates of the quantum mechanical system, wherein k and l are indices of two of said eigenstates.

5. The quantum information processing system according to claim 1, wherein said intentionally changing the state of the quantum mechanical system comprises driving a quantum mechanical state of the quantum mechanical system with at least one driving signal, resetting or cooling the quantum mechanical system, or reading out the quantum mechanical state of the quantum mechanical system.

6. The quantum information processing system according to claim 1, wherein the quantum mechanical environment comprises a dissipative element.

7. (canceled)

8. The quantum information processing system according to claim 1, wherein the at least one coupling location comprises a single coupling location along the length of the coplanar waveguide.

9. The quantum information processing system according to claim 1, wherein the at least one coupling location comprises a plurality of coupling locations, and wherein said intentionally changing the state of the quantum mechanical system comprises driving the state of the quantum mechanical system to a second or third excited state through the at least one coupling location and reading out the state of the quantum mechanical system based on photons absorbed to a quantum mechanical environment through the at least one coupling location as a consequence of a transition from the second or third excited state to a lower excited state.

10. The quantum information processing system according to claim 1, wherein the unimon qubit circuit comprises a multiunimon qubit circuit configured with a plurality of modes configured to act as qubits, and wherein coupling of the plurality of modes is configured to cause coupling between the qubits.

11. The quantum information processing system according to claim 1, wherein the quantum mechanical system comprises a plurality of the unimon qubit circuits coupled to each other and configured to operate as a multi-qubit quantum processor enabling entanglement between qubits.

12. The quantum information processing system according to claim 1, wherein the quantum mechanical environment comprises a quantum circuit refrigerator comprising at least one normal-metal-insulator-superconductor (NIS) tunnel junction electrically connected to the quantum mechanical system, and at least one superconductive lead electrically connected to the at least one normal-metal-insulator-superconductor (NIS) tunnel junction for supplying a drive voltage for said at least one normal-metal-insulator-superconductor (NIS) tunnel junction.

13. The quantum information processing system according to claim 8, wherein quantum mechanical environment comprises an Ohmic resistor or a transmission line.

14. The quantum information processing system according to claim 13, wherein the unimon qubit circuit is configured with substantially two modes, and wherein the single coupling location is based on a ratio of envelope functions of the two modes at the single coupling location.

15. (canceled)

16. The quantum information processing system according to claim 13, wherein the quantum mechanical environment comprises a quantum circuit refrigerator comprising at least one normal-metal-insulator-superconductor (NIS) tunnel junction electrically connected to the quantum mechanical system, and at least one superconductive lead electrically connected to the at least one normal-metal-insulator-superconductor (NIS) tunnel junction for supplying a drive voltage for said at least one normal-metal-insulator-superconductor (NIS) tunnel junction, or wherein the quantum mechanical environment comprises an Ohmic resistor.

17. The quantum information processing system according to claim 1, wherein the quantum mechanical system comprises a plurality of resonator circuits, wherein the at least one coupling location comprises a plurality of coupling locations configured to couple the plurality of resonator circuits to the quantum mechanical environment through a sum of charge or a difference of charge of the plurality of resonator circuits.

18. (canceled)

19. (canceled)

20. (canceled)

21. (canceled)

22. (canceled)

23. The quantum information processing system according to claim 1, wherein a first mode of the unimon qubit circuit is configured for use as a qubit mode, wherein a second mode of the unimon qubit circuit is configured for use as a qubit read-out mode, and wherein the at least one coupling location comprises two coupling locations along the length of the coplanar waveguide.

24. (canceled)

25. (canceled)

26. (canceled)

27. The quantum information processing system according to claim 1, wherein the quantum mechanical system comprises a transmission line, wherein the quantum mechanical environment comprises a quantum circuit refrigerator comprising at least one normal-metal-insulator-superconductor (NIS) tunnel junction electrically connected to the quantum mechanical system, and at least one superconductive lead electrically connected to the at least one normal-metal-insulator-superconductor (NIS) tunnel junction for supplying a drive voltage for said at least one normal-metal-insulator-superconductor (NIS) tunnel junction, wherein the at least one coupling location comprises two coupling locations, and wherein a distance between the two coupling locations is an odd multiple of a half-wavelength of a mode of the transmission line that is configured to be intentionally not filtered.

28. A method for coupling a quantum mechanical system to a quantum mechanical environment, wherein the quantum mechanical system is capable of exhibiting transitions between a plurality of eigenstates, and the quantum mechanical system comprises a unimon qubit circuit comprising a coplanar waveguide, wherein the coplanar waveguide is intercepted by at least one Josephson junction and has a length between its two ends, wherein the unimon qubit circuit is configured with a plurality of modes, the method comprising:
providing at least one coupling location for coupling the quantum mechanical system to the quantum mechanical environment, wherein the quantum mechanical environment is capable of exhibiting modes from a continuous spectrum, and wherein said coupling is characterized with a set of parameters of the quantum mechanical system; and
coupling the quantum mechanical system to the quantum mechanical environment through the at least one coupling location, wherein a selected combination of the at least one coupling location and the set of parameters intentionally causes to suppress at least one of said transitions when intentionally changing a state of the quantum mechanical system by the quantum mechanical environment.

29. The quantum information processing system according to claim 17, wherein the plurality of resonator circuits have substantially the same resonance frequency.

30. The quantum information processing system according to claim 17, wherein at least one of the plurality of resonator circuits is tunable to the substantially the same resonance frequency.
